(19) United States
(12) Patent Application Publication
(10) Pub. No.: US 2015/0257405 A1
(43) Pub. Date: Sep. 17, 2015

(54) Myceliated Coffee Products and Methods for Making Myceliated Coffee Products

(71) Applicant: MYCOTECHNOLOGY, INC., Aurora, CO (US)

(72) Inventors: Brooks John KELLY, Boulder, CO (US); James Patrick LANGAN, Denver, CO (US)

(21) Appl. No.: 14/659,057

(22) Filed: Mar. 16, 2015

Related U.S. Application Data
(63) Continuation of application No. PCT/US14/29998, filed on Mar. 15, 2014.
(60) Provisional application No. 61/953,821, filed on Mar. 15, 2014.

(51) Int. Cl. A23F 5/02

(52) U.S. Cl. CPC A23F 5/02

(57) ABSTRACT

The present invention provides a method for the preparation of a myceliated coffee product. This method comprises providing green coffee beans and optionally heat treating the green coffee beans to provide prepared green coffee beans. Furthermore, a step of inoculating the prepared green coffee beans with a prepared fungal component and culturing the inoculum to prepare the myceliated coffee product is included. The present invention discusses different embodiments of the invention and the various products that can be developed by altering certain parameters, such as green coffee bean moisture content. The methods of the instant invention result in prepared green coffee beans and myceliated coffee products having reduced levels of undesirable taste components, such as 2-furanmethanol, and increased levels of fungal metabolites, such as β-glucans and other polysaccharides, relative to starting green coffee beans.

### CROSS-REFERENCE TO RELATED APPLICATIONS

This application claims priority to pending U.S. Provisional Application Ser. No. 61/953,821 entitled “Myceliated Coffee Products and Methods for Making Myceliated Coffee Products”, filed Mar. 15, 2014; this application also claims priority as a continuation to pending WIPO application PCT/US 14/29989, filed Mar. 15, 2014, entitled “Myceliated Coffee Products And Methods For Making Myceliated Coffee Products,” and the disclosure of each is hereby incorporated by reference herein in their entirety.

### TECHNICAL FIELD

The field of the invention falls under the category of myceliated agriculture. More specifically, the field is concerned with the use of mycotechnological methods to alter the taste and nutritional profile of various coffee products.

### BACKGROUND

Myriad methods have been employed to change the nutritional and taste value of coffee, including mixing coffee grounds with powdered fruit-body and fermenting green coffee beans by passing them through animal gastrointestinal tracts. The first process has the benefit of providing exogenous nutritional value from fungal metabolites, while the second process ameliorates the bitter flavors of the coffee through bacterial fermentation. Adding fruit-body powder does little to change the flavor of the coffee, though does introduce fungal flavors. Furthermore, the fermentation process discussed above proposes a method that does little to improve the nutritional value of coffee beans while processing them through sanitarily dubious methods. It also encourages the practice of animal cruelty for the sake of production volume.

U.S. Patent Publication 20100239711 A1 to Pei-Jung Li et al. describes a method for manufacturing coffee by solid-state fermentation using filamentous fungi. Provided green coffee beans are deposited into a dust-free container, the coffee is wetted and inoculated with a fungal strain grown on a granulated inorganic mineral base, supplemented with ingredients such as peptone and yeast extract. Antrodia camphorata, a fungus native to Taiwan, is primarily utilized. The myceliation of the green coffee takes between 15 to 60 days, while the preparation of the media can take many months. The entire disclosure of Patent Publication 20100239711 is incorporated herein by reference in its entirety.

A need remains in the art for coffee products having reduced levels of undesirable taste components and/or increased levels of health promoting components relative to conventional green coffee beans, and for methods of obtaining such products.

### BRIEF DESCRIPTION OF THE DRAWINGS

FIG. 1 is shows the relative abundance of a number of different toxic/bitter compounds in coffee treated by the methods of the present invention (“Reishi coffee”) versus control coffee, not treated by methods of the present invention.

### SUMMARY OF THE INVENTION

In one embodiment, the present invention provides a method for the preparation of a myceliated coffee product. This method includes the step of providing prepared green coffee beans, which includes providing green coffee beans, optionally hydrating the provided green coffee beans, and sterilizing or pasteurizing the optionally hydrated green coffee beans to provide prepared green coffee beans. The method also includes the step of providing a prepared fungal component. The method comprises inoculating the prepared green coffee beans with the prepared fungal component and culturing the inoculated prepared green coffee beans to prepare myceliated green coffee beans, drying the myceliated green coffee beans, and roasting the dried myceliated green coffee beans to prepare the myceliated coffee product.

In one embodiment, the method includes reducing concentrations of undesirable taste components in the prepared myceliated coffee product. Undesirable taste components comprise 2-furanmethanol, 1-methyl pyrimidine, and diketopiperazine.

The methods of the invention include screening a number of strains of fungi and selecting a strain having an enhanced ability to grow on, metabolize, or utilize green coffee beans and/or selecting a strain that is capable of enhanced removal of one or more undesirable taste components from the green coffee beans, and/or enhanced removal of caffeine from the green coffee beans.

In another embodiment, the prepared fungal component is maintained on an undefined organic food media comprising an aqueous green coffee bean extract. Such maintenance of the fungus causes adaptations enhancing the fungus's ability to grow on, metabolize, or catabolically utilize green coffee beans.

The methods discussed herein disclose the use of submerged liquid tissue culture as an inoculant source for sterilized green coffee beans, the inoculant being grown in an organic food medium. Other sources of inoculant are discussed, though the use of solid-state fermentation media as described by Li is avoided in order to maintain a human-grade product.

The methods of the instant invention result in myceliated coffee products having reduced levels of undesirable taste components and increased levels of fungal metabolites, such as (1->3)(1->6) β-glucans and other polysaccharides, relative to conventional green coffee beans.

The provided green coffee beans may be from any plant of the genus Coffea, such as C. arabica or C. robusta (also known as C. canephora). Also included in the invention are any derivative species of coffee including any strains or cultivars of genetically-modified (GMO) or heirloom (non-GMO) varietals of Coffea.

In some embodiments, determination of the extent of the removal of at least one undesirable taste component is determined by the appearance, taste, and/or chemical composition of the myceliated coffee product. Alternatively, the green coffee bean's appearance or chemical composition may be determined by known methods. This determination may be quantitative, e.g., the chemical composition of the myceliated coffee product may be measured by assay or spectroscopic methods, or determined qualitatively by taste testing by skilled persons.

Removal of undesirable taste components may allow for increasing the value of poorer quality coffee and/or rendering it more drinkable. Myceliated coffee products produced by this method may be used to blend with less expensive coffee beans leading to a lower cost product having improved taste properties. The amount of sugar, milk, and other substitutes to be added to the coffee may be reduced. The instant methods disclosed herein lead to enhanced flavor profile of the myceliated coffee products due to a perception that the myceliated coffee products provide a richer, smoother, and/or sweeter coffee with less bitter, harsh, and/or acidic tastes compared to conventional coffee.

### DETAILED DESCRIPTION OF THE INVENTION

In one embodiment, the present invention provides a method for the preparation of a myceliated coffee product. This method includes the step of providing prepared green coffee beans, which includes providing green coffee beans and sterilizing the green coffee beans to provide prepared green coffee beans. The method also includes the step of providing a prepared fungal component. The method also comprises inoculating the prepared green coffee beans with the prepared fungal component and culturing the prepared green coffee beans and prepared fungal component to allow myceliation to produce the myceliated coffee product. These steps may be performed in any order.

In one embodiment, prepared green coffee beans are provided, which includes the step of providing green coffee beans. Coffee refers to genus Coffea which is a genus of flowering plants whose seeds, called coffee beans, are used to make coffee. It is a member of the Rubiaceae family. Coffee beans may be selected from one of several coffee varieties which are diverse cultivars derived through selective breeding or natural selection of coffee plants. Coffee beans of the same variety grown in different locations may have distinctive characteristics such as flavor (flavor criteria include terms such as “citrus-like” or “earthy”), caffeine content, body or mouthfeel, and acidity. Green coffee beans useful for the present invention may be any species of coffee, including Coffea arabica and Coffea robusta (also known as Coffea conephora); additional species of coffee useful for the present invention include Coffea benghalensis, or Bengal coffee; Coffea congensis, or Congo coffee; Coffea liberica, or Liberian coffee; Coffea stenophylla, or Sierra Leonian coffee; Coffea excelsia, another Liberian coffee; Coffea bonnieri; Coffea gallienii; and Coffea mogeneti. The invention includes any varietals or strains of the species listed above. For example, many Arabica varietals are named after the country or region in which they are predominantly found, or in which they originated. Some of the exemplary varietals of Arabica coffee include Typica, Bourbon, Caturra, Catuai, Mundo Nova, and Blue Mountain. Also included in the invention are and derivative species of coffee including any genetically-modified (GMO) strains or cultivars and also any heirloom variety (non-GMO) strains or cultivars of coffee.
A green coffee bean refers to a raw, unroasted coffee bean. Generally, the raw fruit of the coffee plant is referred to as a coffee cherry. To prepare the green coffee bean, generally, the coffee cherry has the fruit or pulp removed and the seed, or fruit, is then dried. Fruit and pulp may be removed from the green coffee bean by various methods known in the art and include a wet process where the fruit/pulp is removed from the coffee bean prior to drying, and a dry process where the whole cherries are dried prior to mechanical hulling, sorting, grading, and bagging takes place. Dried coffee beans useful for the instant process may include dried coffee beans that are fresh, or may be subject to an aging process. Dried coffee beans may be stored in burlap bags, lined burlap bags, or in vacuum sealed containers prior to entry into the instant process.

In some embodiments, the green coffee bean is not dried prior to being used in the processes of the instant invention. In this embodiment, after the green coffee bean is harvested, the green coffee bean has the pulp removed by any processes known in the art, and then can be used in the present invention without further green coffee bean treatment, such as drying. In this embodiment, the hydration and/or washing step as described below is not necessary or is obviated by the use of the undried green coffee bean

### Providing Green Coffee Beans

Green coffee beans are isolated from the cherry in which they reside through various methods known in the art, including fermentation by ambient microflora and/or mechanical hulling. Once demucilaged, as it is called, they are sorted and dried. Dried coffee beans are typically shipped in burlap bags. In one embodiment of the invention, the provided green coffee beans have been dried. In another embodiment, they have not been dried and can be treated as they are when they come off the tree. This embodiment obviates the hydration step, and optionally the sterilization/pasteurization step, as the beans have a high moisture content right off the tree (generally ˜60%). In this embodiment, the green coffee beans are optionally sterilized/pasteurized and inoculated, either in a prepared container or in the ambient. If the beans have not been dried, the beans will have to be quickly processed, more likely than not on-site.

In one embodiment, the provided dried green coffee beans have been placed in an autoclavable container, such as a polypropylene bag outfitted with a filter breather patch. In another embodiment, the provided dried green coffee beans have been placed in an optionally jacketed food-grade fermentor outfitted for controlled agitation, controlled sterile air/steam injection and exhaust, relative humidity control, temperature control, light control, and optional pressurization capabilities.

### Hydration

Hydration ensures that the green coffee beans have optimal moisture content for myceliation. Hydration, a step that has never been explicitly described in the art, may be accomplished by methods as disclosed herein, or by methods as known in the art. In the embodiment where the dried provided green coffee beans are placed in an appropriately outfitted food-grade fermentor, the beans need not be hydrated if the relative humidity is kept high enough, though experimentation may lead the fermentor operator to hydrate the beans. In this embodiment, the sterilization step aids in mildly hydrating the provided dried green coffee beans.

The hydration may be accomplished by an aqueous medium. The aqueous medium includes water and optionally, additional excipients. Water may be distilled or mineralized. Other excipients can be added to the water, such as buffers to maintain a certain pH, sodium chloride, citric acid and/or ascorbic acid. The pH may be neutral or adjusted. The temperature of the aqueous medium may be room temperature, or elevated in temperature to accelerate the hydration process. In the embodiment where the provided dried green coffee beans are placed into an autoclavable container, clean (e.g. RO filtered) water is added to the container holding the provided dried green coffee beans. One can calibrate the moisture content of the provided green coffee beans according to the following equation:

Let: m=coffee mass (kg), mcᵢ=initial green coffee bean moisture content, x=volume of water to be added (L), and mc_{f}=desired final green coffee bean moisture content

$$m {c}_{f} = \frac{( m * m {c}_{i} ) + x}{m + x}$$

By solving for x, one can determine how much water is added to the container for whatever desired moisture content. The moisture content will affect the sterilization and myceliation process, as will be discussed later in this disclosure. This method works because the added water is ˜100% absorbed during the sterilization/pasteurization step.

Hydration may be accomplished by allowing the green coffee beans to soak in the aqueous medium for any appropriate length of time, ranging from a few seconds or less to overnight. The soaking step for the hydration and/or aqueous extraction step may be less than a second, at least five seconds, at least ten seconds, at least thirty seconds, at least a minute, at least five minutes, at least ten minutes, at least twenty minutes, at least thirty minutes, at least forty minutes, at least fifty minutes, at least an hour, at least an hour and a half, at least two hours, at least two and a half hours, at least three hours, at least four hours, at least five hours, at least six hours, at least seven hours, at least eight hours, at least ten hours, at least twelve hours, or at least fifteen hours, at least eighteen hours, at least twenty four hours, at least thirty six hours, or at least forty-eight hours. However, the time for the hydration step should be selected in view of the fact that the green coffee beans are not sterile and soaking for too long of a time may encourage the growth of undesirable organisms.

In one embodiment, the water for hydration is added to the provided green coffee bean in the container in which the green coffee beans will be myceliated, which is also typically the container they are sterilized/pasteurized in. In this embodiment, it is preferable that the container holding the provided green coffee beans container is not inverted. Inversion of the container is not preferred when the container is, for example, a ball jar outfitted with a lid that has a tin foil collar and modified to allow for some air transfer. If the container is an autoclavable bag, then the bag should be wrapped around the beans, not the beans around the bag, and then loosely wrapped with, for example, EPDM bands. Inversion during the hydration process may result in the added water to be held in spaces that prevent ˜100% absorption during the sterilization step. Provided dried green coffee beans can be hydrated according to the equation above when they are placed into a food-grade fermentor outfitted as described, though inversion of the fermentoris unlikely to occur. The green coffee beans may be hydrated at any temperature that allows for effective hydration; in one embodiment, the temperature of the aqueous component temperature is room temperature. Hydration temperature should be selected in view of the fact that at high temperatures, desirable flavor components may be altered

Moisture content of the hydrated green coffee beans is optionally between about 20 and about 95% moisture content, or between about 40% and about 70% moisture content. In one embodiment, the moisture content is at least about 40%, at least about 50%, or at least about 60%.

The hydration step may occur in a number of different types of container. In one embodiment, the container is a drum, such as a 55 gallon drum.

In another embodiment, green coffee beans that have been demucilaged but not yet dried, which on average have a moisture content of 60%, may be used. This method avoids the hydration step.

In one embodiment, the step of providing prepared coffee beans optionally includes a step of removing undesirable taste components by washing or rinsing the green coffee beans. The wash or rinse may be the aqueous medium as described above. In one embodiment, the green coffee beans are optionally washed or rinsed prior to, during, or after the optional hydration step. Washing, draining and/or rinsing the green coffee beans can be performed by any method known in the art. The green coffee beans may be washed one time, at least two times, at least three times, at least four times, at least five times, at least ten times, at least fifteen times, at least twenty times, at least fifty times or more. In one embodiment the wash step is performed two times. The wash or rinse step may include optional soaking times as described herein.

In one embodiment, the green coffee beans are washed by a method of filling a container holding the green coffee beans with water, allowing the water to soak for 10 seconds to 4 hours, draining the water off and repeating the steps as many times as desired, or to raise the beans to the desired moisture level. The washing or rinsing step may also be carried out until the green coffee beans have had a determined amount of undesirable taste component removed.

The green coffee beans may be washed at any temperature that allows for the efficient extraction of undesirable taste components; in one embodiment, the temperature of the aqueous medium temperature is room temperature. Wash temperature should be selected in mind of the fact that at high temperatures, desirable flavor components may be altered, destroyed and/or extracted.

In another embodiment, the excess aqueous medium or component is removed and/or separated and/or drained from the hydrated coffee beans after the hydration step. This step may also be referred to as an aqueous extraction step. This step may be done to remove undesirable taste components.

The major components of coffee include caffeine, minerals, tannic acid, cellulose, water, fat, protein and fibers. Coffee contains methylxanthine such as caffeine, theophylline, and theobromine, flavonoids, phenols, phenolic acids, volatile alkaloids, non-volatile alkaloids. Coffee contains some undesirable taste components as well. These components will contribute to a perception of a harsh and/or bitter taste to the coffee. These tastes are commonly mitigated by addition of sugar or cream to mask the bitter components. Reduced bitterness and/or harshness is noted in more premium, expensive coffee varieties such as Arabica coffee. Undesirable taste components include compounds such as 2-methyl-pyrimidine, furfural, 2-furanmethanol, quinone isomers, 5-methyl-2-furancarboxaldehyde, 3-hydroxy-4-methyoxy benzaldehyde, chlorogenic acid, caffeine, and diketopiperazine.

The hydration step, aqueous extraction step, wash and/or rinse step can optionally reduce and/or remove undesirable taste components from the green coffee beans and may be carried out as described herein until the desired amount of undesirable taste component has been removed from the green coffee beans.

Green coffee beans (and roasted conventional coffee beans) are known to contain a number of components which contribute to a harsh or bitter flavor. These flavor components are considered undesirable in coffee. One such component is chlorogenic acid which is an ester of caffeic acid and quinic acid and may be described as an acrylic acid derivative. During roasting the smoke from the coffee is toxic to the respiratory tract. Chlorogenic acids contribute to a harsh and/or bitter taste in coffee and coffee products, and may be toxic to both humans, mammals, and various strains of fungi.

Chlorogenic acid has a green color and its presence in the green coffee beans contributes to the green color of the beans. Optionally, even where steps are performed to remove chlorogenic acid while creating the prepared green coffee beans, at least some amount of chlorogenic acid is left in the prepared green coffee beans, as it contributes to the characteristic taste of coffee. In some embodiments at least some chlorogenic acid in the green coffee beans is retained. Chlorogenic acid has been reported to carry certain health benefits, particularly in its ability to mediate insulin levels and thus aid in adipose metabolism. It has also been identified as a powerful antioxidant. Chlorogenic acid is converted to a lactone upon roasting as a result of dehydration at the quinnic acid moiety. The lactone may be incorporated into macromolecules known as melanoidins, molecules that mass upwards of 25,000 kD and are the result of numerous and subsequent Maillard reactions (any of the carbonyls or hydroxyl groups on the lactone could serve as nucleophiles in this reaction), making them less bioavailable than in pure form. Moreover, extensive roasting (i.e. dark roast) will degrade the lactone into hydroxylated phenylindanes. Therefore the roasted myceliation product may not contain chlorogenic acid, rather it may contain the lactone. The chlorogenic acid lactone bio-functionalities are much less understood. Chlorogenic acid has also been implicated as an important tastant in coffee taste profile.

If quantitative removal of chlorogenic acid from green coffee beans is desired, green coffee beans may be autoclaved in excess water; for example 1 lb green coffee beans may be mixed in 3 L of water and autoclaved on a liquid cycle for 30-80 minutes, resulting in nearly white beans. However, quantitative removal of chlorogenic acid is not preferred.

Without being bound by theory, the inventors believe that green coffee beans' chlorogenic acid can reduce the growth of at least some of the fungal strains of the present invention and may further interfere with some or all of the processes of the present invention by interfering or reducing growth of the fungi and/or ability of the fungi to metabolize, or myceliate, the green coffee beans. When chlorogenic acids are not removed from the green coffee beans, higher moisture contents (for example, 60%) of the green coffee beans are preferred. Removal of at least some of the chlorogenic acid allows for the culturing or myceliation step to occur at lower moisture content such as 30% and greater. The inventors attribute this to coffee's 20% cellulose content.

In some embodiments, as optionally measured by the intensity and/or presence of green color of the green coffee beans, the aqueous extraction, wash and/or rinse step is carried out until about 5% of chlorogenic acids are removed; in other embodiments, up to 10%, up to 15%, up to 20%, up to 25%, up to 30%, up to 35%, up to 40%, up to 45%, up to 50%, up to 55%, up to 60%, up to 65%, up to 70%, up to 75%, up to 80%, up to 85%, up to 90%, or up to 95% of chlorogenic acids are removed in the processes of the instant invention. In some embodiments, about 25% to about 80% of the chlorogenic acids are removed. In one embodiment, about 45-50% of the chlorogenic acids are removed.

Other undesirable taste components contributing to a bitter taste in coffee include quinic acid, 5-hydroxymethylfurfural, 2-methylfuran, furfuryl alcohol, trigonelline, caffeic acid, citric acid, malic acid, lactic acid, pyruvic acid, acetic acid, pyrazine, thiazole, quinolone, phenylpyridine, caffeine, 2-methyl-pyrimidine, 2-furanmethanol, quinone isomers, 5-methyl-2-furancarboxaldehyde, 3-hydroxy-4-methoxy benzaldehyde, diketopiperazine, among others. Robusta coffee contains higher levels of both caffeine and chlorogenic acids, and other undesirable taste components, leading to increased bitterness and astringency in Robusta coffee. Undesirable taste components therefore can include one or more of theophylline, theobromine, paraxanthine, liberine, methylliberine, trigonelline (N-methylnicotinate); hydrophobic amino acids such as isoleucine, leucine, valine, tyrosine, phenylalanine, gamma-aminobutyric acid; diketopiperazines such as cyclo(proline-proline), cyclo(prolineleucine), and cyclo(proline-isoleucine); acetic acid, propionic acid, butanoic acid, pentanoic acid, hexanoic acid, heptanoic acid, octanoic acid; nonanoic acid; decanoic acid and derivatives of such fatty acids; 3-methyl-valeric acid, acetaldehyde, propanal, butanal, pentanal; carboxylic acid-5-hydroxytryptamides with an amide bond to fatty acids (unsaturated C6 to C24); the triglycerides linoleic acid, palmitic acid and related esters; diterpenes including cafestol, kahweol, 16-O-methyl-kafestol, cafestal and kahweal; chlorogenic acids; polyphenols; and chlorogenic acids such as ferulic acid and 3,4-dimethoxycinnamic acid, which are connected by an ester bond to the hydroxyl groups of quinic acid. Other harsh and/or bitter flavor components include chlorogenic acid lactones and breakdown products of the lactones such as phenylindanes. One or more of the above-named compounds may be reduced and/or removed by the methods of the invention.

In some embodiments, determination of the extent of the removal of at least one undesirable taste component is determined by the appearance, taste and/or chemical composition (by methods known in the art) of the myceliated coffee product. Alternatively, the green coffee bean's appearance or chemical composition may be determined by known methods. This determination may be quantitative, e.g., the chemical composition of the myceliated coffee product may be measured by assay methods, or determined qualitatively by taste testing by skilled persons.

In one embodiment, up to 5% of one or more of the undesirable taste components are removed; in other embodiments, up to 10%, up to 15%, up to 20%, up to 25%, up to 30%, up to 35%, up to 40%, up to 45%, up to 50%, up to 55%, up to 60%, up to 65%, up to 70%, up to 75%, up to 80%, up to 85%, up to 90%, or up to 95% of one or more of the undesirable flavor components are removed in the processes of the instant invention. In one embodiment, one or more of the undesirable flavor components are quantitatively removed.

Removal of undesirable taste components may allow for increasing the value of poorer quality coffee and/or rendering it more drinkable. Myceliated coffee products produced by this method may be used to blend with less expensive coffee beans leading to a lower cost product having improved taste properties. The amount of sugar, milk and substitutes thereof to be added to the coffee may be reduced. The instant methods lead to enhanced flavor profile of the myceliated coffee products due to a perception that the myceliated coffee products provide a richer, smoother, and/or sweeter coffee with less bitter, harsh, and/or acidic tastes. Green coffee beans and myceliated coffee beans that have been subjected to the hydration and/or aqueous extraction steps as described above will have reduced amounts of chlorogenic acid. Myceliated coffee products of the present invention will demonstrate improved flavor. In one embodiment, the improved flavor results from removal and/or reduction of bitter-tasting compounds such as chlorogenic acid in the myceliated coffee beans.

In one embodiment, reduction of the desirable flavor components such as volatile oils is minimized by the processes of the present invention. In processing green coffee beans from Robusta coffee, the art teaches to steam treat, steam extract, or stream strip the beans prior to roasting, which can remove many desirable volatile oils from the Robusta coffee beans. The processes of the instant invention avoid the steam roasting step for Robusta coffee beans, thereby helping to preserve the desirable volatile oils that contribute to coffee flavor.

In an optional step, coffee beans can be decaffeinated by conventional processes prior to, subsequent to, or in addition to the methods of the instant invention

### Sterilization/Pasteurization

The methods of the present invention further optionally comprise a method of heat treatment (e.g. pressurized saturated steam treatment) to effect, in one embodiment, a pasteurization, and in another embodiment, a sterilization of the optionally hydrated provided green coffee beans to provide prepared green coffee beans. This step may be accomplished by any method known in the art or by methods disclosed herein.

As an example of pasteurization, hydrated green coffee beans may be subjected to dry heat treatment at atmospheric pressure at temperatures of about 145 to 190° F. for 30 to 90 minutes, or alternatively at 140 to 210° F. for 20 to 100 minutes.

Sterilization of the green coffee beans may be performed as is known the art. For example, green coffee beans may be sterilized by heating under a pressure of 15 lb/in² at 121 to 122° C. for 20 to 150 minutes, such as 120 minutes, depending on size of the batch and conditions of the sterilization. In another embodiment, the steam is superheated to 122 to 125° C. The pressures may vary from 5 to 25 lb/in², depending on the altitude of the processing location. Green coffee beans may be sterilized in a container as described in the embodiments above. The container, in some embodiments, should not be sealed. In one embodiment, hydrated provided green coffee beans in an autoclavable container are sterilized in a pressure vessel, such as an autoclave (bags can be sterilized on a liquid cycle). In another embodiment, hydrated provided green coffee beans are sterilized by injecting saturated steam at pressures and temperatures described above into the food-grade fermentor holding the beans. In this embodiment, the beans should be agitated during the sterilization to ensure even heat treatment for eventual homogenous roasting profiles. Biological tests using Bacillus stearothermophilus can be used to ensure and optimize sterilization cycles.

The sealed container of some embodiments can provide some advantages. For example, sealing the container minimizes outflow of flavor components and aromatic components from the green coffee beans, which can be noticed by the lack of coffee aroma from steam from the pressure cooker or autoclave during the sterilization process. Sealing also prevents water-soluble flavor and aromatic components from escaping the green coffee beans directly into steam, hot air, or heated water.

Suitable containers include containers known in the art for mushroom cultivation. Optionally the containers have a section for exchanging air or gases but do not allow passage of any other component. Such sections are known in the art and include filter strips. In one embodiment, the container is a drum, for example, a 55 gallon drum.

In some embodiments, the containers of the instant invention can be glass, stainless steel, temperature-resistant high density polyethylene or polypropylene bags. Fermenters and bioreactors can also be used as containers of the instant invention. In some embodiments, the containers have a means for gas exchange that precludes passage of contaminants, such as filter zones or valves.

In one embodiment the container is a bag, for example, an autoclavable, polypropylene bag with filter strips, an autoclavable, high density polyethylene bag with filter zones, and a gamma-irradiated polyethylene bag with filter zones

The size of the bags to be used can be chosen according to the mass of green coffee beans intended for treatment by the methods of the present invention. Exemplary amounts of green coffee beans to use per bag include 1 to 150 kg of green coffee beans, although larger and smaller amounts of green coffee beans are contemplated. For example, amounts of 0.001 to 100,000 kg of provided green coffee beans can be treated by this method in a single batch, if the fermenter is large enough.

In another embodiment, the green coffee beans are vacuum packed in the bags to eliminate air that could draw volatile flavor or aromatic components from the bags.

In another embodiment, the bags are replaced by sheets of autoclavable material, such as BPA-free plastic. One base sheet is continuously dispensed along the top of a conveyor, green coffee beans are then laid on the dispensed base sheet. A second top sheet is overlaid upon the green coffee beans and sealed to the base sheet. A vacuum is applied between the top and bottom sheet to evacuate air, then the sheets are sealed at predetermined distances to form sections. Each section holds a pre-determined volume of green coffee beans. The sections are conveyed through an autoclave, or oven, to effectuate the pasteurization or sterilization process. Heat may be applied in a pressurized or non-pressurized environment in the form of steam, hot water under pressure, hot air in turbulent or laminar flow over the sheets, or other heated fluid. In a variation of this embodiment, the sections containing the green coffee beans are rolled and placed in an autoclave for pressurization or sterilization. One roll can contain many sections. Once sterilized, the green coffee beans are optionally cooled to approximately 60 to 90° F. before being inoculated. This process can be accomplished by any method known in the art, and hastened through the use of central air temperature control, refrigerators, heat exchangers, or glycerol chillers.

### Fungal Component

The fungal component to use with the present invention can be any edible mycelium, including fungi from the phyla Basidiomycotina and Ascomycotina, including the species: Hericium erinaceus, Pleurotus ostreatus, Pleurotus eryngii, Pleurotus citrinopileatus, Pleurotus djamor, Trametes versicolor, Lentinula edodes, Armillariella mellea, Tricholoma matsutake, Flammulina velutipes, Volvariella volvacea, Agaricus campestris, Agaricus blazei, Grifola frondosa, Pholiota nameko, Boletus edulis, Ganoderma lucidum, Ganoderma applanatum, Hypsizygus marmoreus, Morchella hortensis, Morchella angusticeps, Morchella esculenta, Phellinus linteus, Auricularia auricula, Tremella fuciformis, Inonotus obliquus, Fomes fomentarius, Laetiporus sulfureus, Cordyceps sinensis, Cordyceps militaris, Cantharellus cidarius, and Polyporus umbellatus. Combinations of the above identified strains are also contemplated, in both the myceliation step and in the mixing of myceliated coffee products. In some embodiments, the present invention utilizes Ganoderma lucidum or Cordyceps sinensis

Generally, the invention preferably does not use the following fungi: Rhizopus chinensis, R. oligosporus, Aspergillus flavusoryzae, A tamari, A. niger, A. nidulans, A. sojae, Fusarium venenatum, F. graminearum, Saccharomyces cerevisiae, S. exiguous, S. pombe, Saccharomycopisis (Candida) lipolytica, Candida utilis, C. krusei, C. tropicalis, Pichia saitoi, Kluyveromyces fragilis, Endomycopsis fibuliger, Chaetomium spp., Zygosaccharomyces rouxii, Mucor racemosus, Geotrichum candidum, Penicillium camemberti, P. notatum, P. griseofulvuum, P. grisea, P. chrysogenum, P. roqueforti, P. nalgiovense, Neurospora intermedia, Amylomyces rouxii, Endomycopsis burtonii, Antrodia camphorata, Monascus purpureus, Debaryomyces hansenii, Ashbya gossypii, Blakeslea trispora, Tolypocladium niveum, T. inflatum, Tuber melanosporum, Streptomyces spp., Neocosmospora spp., Stachybotrys spp., Beauveria spp., Cephalosporium acremonium, Gibberella fujikuroi, Fusidium coccineum, Monascus ruber, Claviceps Fusiformis, C. paspali, C. purpurea, Amanita muscaria, or A. phalloides.

Fungal components useful in the present invention may be prepared by methods as described herein. For example, in one embodiment, a pure strain of fungus is used. In some embodiments, the pure strain of fungus is able to effectively grow on and/or myceliate the prepared green coffee beans to prepare the myceliated coffee products. Any edible strain of fungus identified herein which is capable of effectively modifying the flavor of, growing on, and/or myceliating prepared coffee beans can be used for the methods of the present invention.

It was surprisingly found by the inventors of the instant invention that some fungal strains have enhanced and/or increased ability to grow on, metabolize, or otherwise utilize and/or modify green coffee beans and/or remove one or more undesirable taste components from the green coffee beans and/or better tolerate the presence of green coffee beans (or extract) in media. In one embodiment, the undesirable taste component is 2-furanmethanol. In another embodiment, the fungal component reduces or removes caffeine from green coffee beans.

Therefore, the methods of the invention have as an optional additional step, a method of selecting a fungal component having an enhanced and/or increased ability to grow on, metabolize or otherwise utilize and/or modify green coffee beans and/or remove one or more undesirable taste components from the green coffee beans, and/or remove caffeine and/or better tolerate the presence of green coffee beans (or extract) in liquid and/or solid-state media. This method comprises screening a number of strains of a desired fungal species to select for a suitable fungal component (strain) which exhibits the enhanced and/or increased ability to grow on, metabolize, or otherwise utilize and/or modify green coffee beans and/or remove one or more undesirable taste components and/or caffeine from the green coffee beans, and/or is better able to tolerate the presence of green coffee beans, and using this selected strain(s) in the methods of the invention. In one embodiment, a pure strain of any commercially available Ganoderma lucidum is used as the fungal component. While all strains of Ganoderma lucidum are effective for the present invention, it was surprisingly found that some selected strains have the enhanced abilities useful for the present invention as described herein. One such strain useful for the fungal component of the present invention is Ganoderma lucidum strain 806, (Alice Chen; Buffalo, N.Y.; 4/94) commercially available from Pennsylvania State University (The Pennsylvania State University Mushroom Culture Collection, available from the College of Agriculture Sciences, Department of Plant Pathology and Environmental Microbiology, 117 Buckhout Laboratory, The Pennsylvania State University, University Park, Pa., USA 16802.)

This strain was surprisingly determined by the present inventors to more efficiently grow on, metabolize or otherwise utilize and/or modify green coffee beans and/or tolerate green coffee beans and/or remove one or more undesirable taste components from the green coffee beans, including chlorogenic acid. In another embodiment, this strain can remove and/or reduce the amount of caffeine in green coffee beans. Therefore, in one embodiment, the fungal component is Ganoderma lucidum strain 806 Alice Chen; Buffalo, N.Y.; 4/94. These selected strain(s) were deposited with ATCC as described hereinbelow.

In one embodiment, a pure strain of any commercially available Cordyceps sinensis is used as the fungal component. While all strains of Cordyceps sinensis are effective for the present invention, it was surprisingly found that some selected strains have the enhanced abilities useful for the present invention as described herein. One such strain useful for the fungal component of the present invention is Cordyceps sinensis (Strain 1009 Caterpillar Fungus; Colorado Corp, 1/2014), commercially available from Pennsylvania State University (The Pennsylvania State University Mushroom Culture Collection, available from the College of Agriculture Sciences, Department of Plant Pathology and Environmental Microbiology, 117 Buckhout Laboratory, The Pennsylvania State University, University Park, Pa., USA 16802.) These selected strain(s) were deposited with ATCC as described hereinbelow.

This strain was surprisingly determined by the present inventors to more efficiently grow on, metabolize or otherwise utilize and/or modify green coffee beans and/or remove one or more undesirable taste components from the green coffee beans, including chlorogenic acid and/or better tolerate the presence of green coffee beans (or extract) in media. In another embodiment, this strain can remove and/or reduce the amount of caffeine in green coffee beans. Therefore, in one embodiment, the fungal component is Cordyceps sinensis (Strain 1009 Caterpillar Fungus; Colorado Corp, 1/2014). These selected strain(s) were deposited with ATCC as described herein below Similarly selected strains for Hericium erinaceus, Pleurotus ostreatus, Pleurotus eryngii, Pleurotus citrinopileatus, Pleurotus djamor, Trametes versicolor, Lentinula edodes, Armillariella mellea, Tricholoma matsutake, Flammulina velutipes, Volvariella volvacea, Agaricus campestris, Agaricus blazei, Grifola frondosa, Pholiota nameko, Boletus edulis, Ganoderma lucidum, Ganoderma applanatum, Hypsizygus marmoreus, Morchella hortensis, Morchella angusticeps, Morchella esculenta, Phellinus linteus, Auricularia auricula, Tremella fuciformis, Inonotus obliquus, Fomes fomentarius, Laetiporus sulfureus, Cordyceps sinensis, Cordyceps militaris, and Polyporus umbellatus, for example, (or for any species of edible fungi) were thus obtained by screening a number of strains of each species to select for a suitable fungal component (strain) which exhibits the enhanced and/or increased ability to grow on, metabolize, or otherwise utilize and/or modify green coffee beans and/or remove one or more undesirable taste components and/or caffeine from the green coffee beans, and/or is better able to tolerate the presence of green coffee beans, and using this selected strain(s) in the methods of the invention. Therefore, in some embodiments, the selected strain(s) of Hericium erinaceus, Pleurotus ostreatus, Pleurotus eryngii, Pleurotus citrinopileatus, Pleurotus djamor, Trametes versicolor, Lentinula edodes, Armillariella mellea, Tricholoma matsutake, Flammulina velutipes, Volvariella volvacea, Agaricus campestris, Agaricus blazei, Grifola frondosa, Pholiota nameko, Boletus edulis, Ganoderma lucidum, Ganoderma applanatum, Hypsizygus marmoreus, Morchella hortensis, Morchella angusticeps, Morchella esculenta, Phellinus linteus, Auricularia auricula, Tremella fuciformis, Inonotus obliquus, Fomes fomentarius, Laetiporus sulfureus, Cordyceps sinensis, Cordyceps militaris, and Polyporus umbellatus are used in the processes of the instant invention.

All strains referenced herein are deposited with the ATCC at 10801 University Boulevard, Manassas, Va. 20110-2209 USA under the Budapest Treaty provisions. The deposit will irrevocably and without restriction or condition be available to the public upon issuance of a patent and will be maintained under the terms of the Budapest Treaty on the International Recognition of the Deposit of Microorganisms for the Purposes of Patent Procedure. These deposits were made merely as a convenience for those of skill in the art and are not an admission that a deposit is required under 35 U.S.C. §112. However, it should be understood that the availability of a deposit does not constitute a license to practice the subject invention in derogation of patent rights granted by government action. The deposit will be maintained without restriction in the ATCC Depository, which is a public depository, for a period of 30 years, or 5 years after the most recent request, or for the enforceable life of the patent, whichever is longer, and will be replaced if it ever becomes nonviable during that period.

### Maintenance and Adaptation of the Fungal Component

Fungal components useful in the present invention may be prepared by methods as described herein. For example, in one embodiment, the fungal component is optionally grown, maintained, and/or propagated in an undefined organic food medium comprising aqueous green coffee bean extract prior to use for inoculation of the prepared green coffee beans. In one embodiment, the fungal component is indefinitely maintained in the undefined organic food medium comprising aqueous green coffee bean extract in the solid-state, floating, and submerged morphologies. Without being bound by theory, the inventors believe that maintenance of the fungal component on an undefined organic food medium comprising green coffee bean extract plays an important role in the long-term viability and health of the fungal component. It is believed that the perpetual and subtle changes made from batch to batch of agar media when using undefined organic food media comprising green coffee bean extract effectively avoids the phenomenon of undesirable genetic drift that will occur over time to the fungal component when it is maintained on identical iterations of media.

The undefined organic food medium comprising green coffee bean extract may be made by a number of methods. In one embodiment, the undefined medium comprises organic food powder, organic fruit puree, and aqueous green coffee extract. Optionally, additional energy sources can be added. Materials are optionally organic and water at least RO filtered. It has been surprisingly found by the inventors that the medium may comprise aqueous green coffee bean extract without any additional added excipients, such as an additional energy source for growing fungi of the present invention, or food powders or purees.

### Solid Media Comprising Agar, Food Powder, and Aqueous Green Coffee Bean Extract

In one embodiment, an undefined organic food medium comprising aqueous green coffee bean extract and agar is used to culture the fungal component for the eventual purpose of myceliating prepared green coffee beans. In one embodiment, 0.1 to 100 lb of green coffee beans are soaked in 0.1 to 100 L of water for 0.1 to 2 hours. The filtrate was collected through 1 to 3 filtrations of the mixture through a fine mesh colander, and 14 to 60 g/L of agar was added. This base solution can be mixed with 2 to 10 g/L organic potato starch powder and 0.2 to 1 g/L organic carrot powder. In one embodiment the vegetable is potato. Aqueous potato mixture can be prepared by softening 1-300 g of potato mass in boiling or pressurized water, mashed, and the filtrate was collected through 1-3 filtrations. Optionally, organic fruit juice or puree can also be added to the base vegetable powder green coffee agar media at 0.1 to 10% (v/v). Optionally handled glass jars may be used. 1.5 L of media can be placed into a 1 gallon jar as such, with water added to clean down the inner and outer walls of the container. The container is then outfitted with an appropriate lid by methods known in the art. In another embodiment, instead of adding aqueous green coffee extract, a handful of green coffee beans is added to the media prior to sterilization. In one embodiment, the medium comprises 0.1-10% by weight of malt extract, 0.1-10% by weight undefined vegetable extract with essence of green coffee bean, 0.1-10% by weight of yeast extract, 0.1-10% by weight of peptone, 0.1-10% by weight of glucose, 20-80% by weight of water, and 1-90% by weight whole green coffee beans or green coffee bean extract

As a non-limiting example of the media, for example, 2 lbs green coffee beans, either pulverized or whole can be mixed with ¼ gallon water at room temperature. The mixture may be blended. The mixture is then allowed to extract for 20 minutes with shaking, then filtered three times through fine mesh. Separately, about 5 organic potatoes are placed in 10 L of water and autoclaved 20 minutes to soften the potatoes. The potatoes are then pulverized with a potato masher, and then filtered through fine mesh three times. 1 L of commercial unsweetened fruit juice can be added. These solutions are combined and autoclaved Once prepared, the media can be sterilized by any method known in the art. For example, in one embodiment the prepared agar media is sterilized by pressurized saturated steam treatment inside a pressure vessel at 120 to 121° C. Biological tests of Bacillus stearothermophilus can be used to ensure and optimize sterilization cycles. Once cool enough (i.e. the container is just cool enough to touch), the media can be poured into Petri plates to solidify. These plates can be used to propagate fungal cultures from plate to plate, from plate to liquid, or from plate to any prepared media in sterile operation to grow axenic cultures. Slants for test tubes and flasks may be prepared by this method. Petri plates can also be inoculated with floating and submerged liquid tissue culture, and with myceliated substrate.

### Undefined Liquid Media Comprising Aqueous Green Coffee Bean Extract

Green coffee bean extract and undefined vegetable powder and fruit juice/puree can be prepared as described for solid media, except that no agar is added. 4 L Erlenmeyer flasks make for good containers, being filled by about 1.5 L of media, and outfitted with an appropriate lid by methods known in the art. If preparing to make a floating culture, 1 to 10 tablespoons of flour can be added to the mixture, and in one embodiment, about 1 tablespoon per 1 to 5 L of culture. The media can be sterilized by methods known in the art. Once cool, the vessel can be inoculated in sterile operation with a colonized section of Petri plate, from other liquid tissue cultures, or from samples of myceliated substrate.

In one embodiment, the fungal component for inoculation into prepared green coffee beans can be prepared as a submerged liquid tissue culture using the undefined organic food medium comprising green coffee bean extract as defined herein and agitated on a shaker table. In one embodiment, the agitation rate is 50 to 240 RPM, or 85 to 95 RPM, and incubated for 1 to 90 days. In one embodiment, the incubation temperature is 87 to 89° F.

In one embodiment, the fungal component is trained and/or adapted and/or maintained in its ability to efficiently grow on, metabolize or otherwise utilize and/or modify green coffee beans. In one embodiment, the fungal component is selected and/or trained and/or adapted and/or maintained in its ability to remove or reduce one or more undesirable taste components from the green coffee beans or to remove or reduce the amount of caffeine. Methods to determine whether an undesirable taste component and/or caffeine has been reduced or removed has been disclosed herein and also be found in the art.

In one embodiment, the trained and/or adapted and/or maintained fungal component is prepared from disinfected wild and healthy fungi. Such fungi with changed, improved, and adapted properties as described herein, relative to the starting strains, either selected or unselected, were developed by these methods. These adapted strains were deposited with the ATCC as described elsewhere herein. In one embodiment, the trained and/or adapted and/or maintained fungal component is prepared from Ganoderma lucidum. In one embodiment, the trained and/or adapted and/or maintained fungal component is prepared from Ganoderma lucidum strain 806 Alice Chen; Buffalo, N.Y.; 4/94. In another embodiment, the trained and/or adapted and/or maintained fungal component is prepared from Cordyceps sinensis (Strain 1009 Caterpillar Fungus; Colorado Corp, 1/2014). In one embodiment, the trained and/or adapted and/or maintained fungal component is prepared from H. erinaceus, T versicolor, L. edodes, T. matsutake, F. velutipes, A. blazei, G. frondosa, P. nameko, L. officinalis, M. hortensis, M. angusticeps, A. auricula, T. fuciformis, I. obliquus, F. fomentarius, L. sulfureus. In one embodiment, the trained and/or adapted and/or maintained fungal component is prepared from a pure strain of Tuber melanosporum, obtained by culturing a truffle mushroom by the methods described herein. These fungi having changed, improved, and adapted properties as described herein, relative to the starting strains, were deposited with ATCC as described herein.

The training and/or adaption and/or maintenance step as described herein can be optionally conducted on undefined organic food liquid or solid media comprising green coffee bean extract as defined herein. In one embodiment, the fungi may be cultivated for 1 to 90 days at any temperature known in the art for cultivating fungi, for example, 87 to 89° F. Re-inoculation of the cultivated fungal component into fresh media as described herein can be performed at an appropriate time as determined by one of skill in the art depending on the growth rate, growth cycle, and appearance of the fungal component. The cycle of growth and re-inoculation of the fungal component into fresh media, in some embodiments, is performed more than one time, more than two times, more than three times, more than four times, more than five times, more than ten times, more than fifteen times, more than twenty times, more than twenty-five times, more than thirty times, more than forty times, more than fifty times, more than seventy-five times, or one hundred times or more. The fungal component by these methods can, for example, better recognize green coffee beans or any particular component of green coffee beans as an energy source, better tolerate the presence of green coffee bean extract in media (as measured by an enhanced growth rate, for example), better remove undesirable taste components, or better remove caffeine. This effect is amplified by adding specific chemical compounds to the media in sterile operation, such as an undesirable taste component as identified above, including, for example, 2-furanmethanol, 1-methylpyrimidine, diketopiperazine, and/or caffeine.

Therefore, the methods of the invention have as an optional additional step, a method of preparing a trained and/or adapted and/or maintained fungal component comprising a fungal component having an enhanced and/or increased ability to grow on, metabolize, or otherwise utilize and/or modify green coffee beans and/or remove one or more undesirable taste components from the green coffee beans, and/or remove caffeine, and use of the trained and/or adapted and/or maintained fungal component in the present invention. The methods of the invention further comprise use of any of the trained, adapted, and/or maintained fungal component(s) as described herein, in the methods of the instant invention.

### Preparation of Fungal Component for Inoculation of Green Coffee Beans

In one embodiment, methods for preparing the fungal component to inoculate the prepared green coffee beans include scaling up a fungal component as defined herein in liquid culture. Such a fungal component readied for inoculation of the prepared coffee beans is called a “prepared fungal component”.

In one embodiment, the prepared fungal component is in the solid state. In another embodiment, the prepared fungal component is in the liquid state, either of the floating or submerged morphology. Liquid culture can be accomplished by any means known in the art and includes use of a bioreactor, especially in the one embodiment where the prepared green coffee beans are in a food-grade fermenter, wherein an entire bioreactor of culture, for example a 100 L bioreactor, can be used to inoculate large batches of substrate, say, 10,000 lb. For example, when using a bioreactor to prepare the fungal component, the bioreactor can be prepared by diluting undefined liquid organic food media comprising green coffee bean extract up to 1000× with RO/distilled water. Dilution can be 1×, about 2×, about 3×, about 4×, about 5×, about 6×, about 7×, about 8×, about 9×, about 10×, about 15×, about 20×, about 25×, about 30×, about 35×, about 40×, about 45×, about 50×, about 55×, about 60×, about 65×, about 70×, about 80×, about 90×, about 100×, about 150×, about 200×, about 250×, about 300×, about 350×, about 400×, about 450×, about 500×, about 550×, about 600×, about 650×, about 700×, about 750×, about 800×, about 850×, about 900×, about 950×, or about 1000×. In some embodiments, the dilution is about 5× to about 100×. For a 100 L bioreactor, media can be diluted about 10×, for example.

The jacket of the bioreactor may be steamed in one embodiment to sterilize the media, or alternatively, the media can be sterilized by way of injecting steam into the vessel, and in another embodiment, both the jacket and chamber can be steamed to shorten sterilization cycles. The media should be agitated during sterilization.

In one embodiment, to inoculate the reactor, media may be pumped from another reactor through a sterilized line with an inline pump, or by positively pressuring the supply reactor with sparged air from an air compressor that runs the air through inline 0.2/0.5 μm capsule filters then through a check valve with a specific cracking pressure, for example, 2 to 3 psi. Alternatively, the bioreactor can be inoculated from a glycerol stock that has been stored at −20° F. The glycerol stock, which is analogous to submerged liquid tissue culture media adjusted to 40 to 60% glycerol after incubation for 1 to 7 days, can either be poured into the reactor in sterile operation, or attached to an amendment on the reactor that allows for the space between the reactor and the glycerol stock (which, in this embodiment, would be valved off) to be sterilized with steam, cooled, and the subsequent vacuum broken with sterile air, before the culture is added to the prepared bioreactor. In this manner a bioreactor can be inoculated in a non-clean space.

The fungal component may be optionally agitated during culturing by methods known in the art. For example, in a bioreactor, the agitation may be accomplished by a combination of sparged air and a motorized paddle which allows both a turbulent environment and shear mechanical force. The inventors, without limitation, have found that the combination is superior to running either method individually, as sparged air creates the most turbulence at the top half of the culture, while affecting the bottom less, which can be kept agitated by a motorized paddle, while the paddle does not have to run at such a high RPM as normally used in the art. The combination creates the proper small hyphael sphere sizes without damaging the mycelia.

Liquid state fermentation agitation and swirling techniques are known in the art and include mechanical shearing using magnetic stir bars, stainless steel impellers, injection of sterile high-pressure air, and/or the use of shaker tables. Higher agitation and swirling rates, in conjunction with air and media injections, produce smaller mycelial spheres. In some embodiments, the mycelium grows as a floculant culture, depending on the linear combination of agitation methods.

The fungal component can be grown until ready for inoculation of the prepared green coffee beans as determined by one of skill in the art. In some embodiments, the fungal component can be grown for 1 to 10 days prior to use in inoculating the prepared green coffee beans. Determination of whether the fungal cultures comprising the fungal component are suitable for inoculation of the prepared green coffee beans can be determined by one of skill in the art. For example, in one embodiment, the fungal culture, when in liquid media, is suitable for inoculation while in log phase, either early or late. Senescent cultures and cultures in earlier growth phases with lower amounts of mycelia/mL can be used, but are not preferred. The prepared fungal component optionally appears well grown through in the media, with visible mycelia growing through every mL visible by microscope and unassisted vision.

In order to effect the most efficient myceliation of the green coffee, the fungal component has defined hyphael sphere sizes which enables hyphae growth in three dimensions around the spherical conglomeration of the culture of the fungal strain. In one embodiment the hyphael sphere size is less than 10 mm in diameter, less than 2 mm in diameter, less than 1 mm in diameter, less than 100 μm in diameter, less than 10 μm in diameter, less than 5 μm in diameter, less than 2 μm in diameter, or less than 1 μm in diameter. In another embodiment, the hyphael spherical conglomeration has a size range of 5 μm to 5 cm in diameter, or a size range of 10 to 50 μm in diameter.

These methods result in a prepared fungal component for the inoculation of prepared green coffee beans.

### Inoculation and Myceliation of the Prepared Green Coffee Beans

The prepared green coffee beans are inoculated with the prepared fungal component. The prepared fungal component to be used can be any fungal component as defined in the instant invention. The inoculation of the prepared fungal component onto the prepared green coffee beans can be carried out by any method known in the art. This step may be variously referred to as the culturing step, the fermentation step, and/or the myceliation step.

The myceliation may take place in a container as described herein. In one embodiment, the myceliation takes place in a food-grade fermenter outfitted for various purposes as discussed herein. As also discussed, a bioreactor on the orders of magnitude of tens to hundreds of liters can be used to inoculate said fermenter. This can be accomplished in a non-clean space if a harvesting line is connected to a valved off nozzle teed to a valved off vent on the bioreactor. After sterilizing this harvesting line and cooling it, the valve to the harvesting line and the fermenter can be opened, and the bioreactor positively pressured with sterile air to push the inoculant through the line and into the fermenter. The fermenter agitator (ideally an agar, put through a manway with a mechanical seal, or controlled externally by a magnetic drive) should be running to ensure homogenous inoculation. Rate of transfer can be controlled by bioreactor pressure. This step will also provide added hydration to the beans.

In one embodiment, the prepared green coffee beans are cooled to a temperature of between 80 to 90° F. prior to inoculation with the prepared fungal component. Cooling may be accomplished by refrigeration, thermal diffusion, the use of heat exchangers, or through the use of a glycerol chiller. The step of myceliating the prepared green coffee beans can take place for between 1 to 90 days, for between about 7 to 21 days, and in one embodiment, for about five days, and at any temperature that precludes contamination and thermal shock, for example, at 87 to 89° F. Multiplication of the mycelium by cytokinesis is carried out by efficiently controlling environmental light, such as by a control model of 40% lighting and 60% dark, and also by controlling sterile airflow and temperature at 86 to 88° F. or 87 to 89° F., or between 12 to 35° C., or between 24 to 32° C.

Relative humidity of this culturing, myceliation, and/or fermentation step is controlled between 20 to 99%, and in some embodiments, about 70%.

The step of myceliating the prepared green coffee beans is preferably accomplished in an anaerobic or semi-anaerobic environment. Methods known in the art can be used to induce and/or maintain facultative anaerobic metabolic activity of the prepared fungal component as described by the Pasteur Effect. In an alternate embodiment, the prepared green coffee beans are removed from the sheets and deposited in large stainless steel vats in a sterile environment. The vats regulate oxygen levels and temperature, and enable the facultative anaerobic activity and mycelial growth on the prepared green coffee beans. Facultative anaerobic activity metabolizes more cellulose of per unit of time, meaning that the coffee substrate is consumed at a more rapid rate than in an aerobic environment. In some cases mycelial growth is nine times faster than in an aerobic environment (that is, nine times more cellulose molecules are metabolized to ATP). Another benefit is that the anaerobic environment inhibits fruiting body growth. An anaerobic environment also assures a reduction in unwanted bacterial growth, and other unwanted microbial growth.

Expansion of the fungus mycelia is monitored by microscopy, and schedules of growth documented by photography. The longer the incubation period, the greater the production of the mycelium dry weight and the greater the flavor change of the myceliated coffee products. In some embodiments, a general myceliation time of 4 to 10 days can be used. In some embodiments, too much mycelial growth will introduce flavor defects in the brew by way of emphasizing fungal notes. In some embodiments, the moisture content of the coffee in combination with the humidity of the air will prevent vigorous myceliation from occurring (this is exacerbated by the fact that caffeine is a potent general antifungal, which is one of the reasons why the ‘training’ step discussed herein is important and effective). In this embodiment, a time-course flavor change can still be effected. Without being bound by theory, the inventors hypothesize that metabolic activity is still occurring. This hypothesis is formulated based on the observation that fungi plated out on aqueous green coffee bean extract rich media generate a dark ring of exudate that can at times span 2 to 6 cm in diameter. Despite this indication of metabolic activity, colonization might be completely inhibited. For strains whose connoted fungal flavors due to myceliation are considered detrimental (e.g. in the use of Inonotus obliquus or Morchella angusticeps), this embodiment can serve as a viable alternative to vigorous myceliation effected by high moisture content and relative humidity. There are no differences between these embodiments but moisture content and relative humidity. In one example of this novel embodiment, moisture content of the prepared green coffee beans is 25 to 35%, while relative humidity is ˜40%. This will inhibit most strains from growing. Some species will grow vigorously and still effect desired taste changes, such as Tremella fuciformis and some trained strains of Ganoderma lucidum. The inventors have found that the innate mycelial flavor of these strains does not lead to connote any flavor defects. In this embodiment the process will still degrade detrimental taste molecules and imbue the coffee with beneficial fungal metabolites, as has been confirmed by third-party analysis. Testing with strains must be conducted to decide which embodiment is most desired.

Determination of when to harvest the myceliated coffee product may be determined by a number of methods. Harvesting is generally performed with a timing to optimize the taste profile of the myceliated coffee product according to the taste profile desired. For example, the scent profile of the myceliation culture can be used by the trained person to determine when the culture is ready. Determination of the appearance of the culture may also be done by the trained person. In some embodiments, harvesting can be done when the amount of the mycelia in the culture are in the approximate amount of 2-3 fully grown (standard size) petri plates (for G. lucidum), or when the amount of the mycelia are in the approximate amounts of 10-12 fully grown standard petri plates (for C. sinensis), per 8 lbs of coffee. Analytical methods of analysis including high performance liquid chromatography (HPLC), mass-spectroscopy, and UV-VIS spectrophotometry may be employed to carry out measurement of biomolecules in order to determine the optimum composition and cultivation conditions and the appropriate time(s) for harvesting the myceliated coffee product.

In a non-limiting example of the present invention, about 8 lb of prepared green coffee beans in an autoclavable bag with a 0.2 μm breather patch was inoculated with about 400 mL of prepared G. lucidum submerged in a 4 L flask. The myceliation proceeded for 7 days at 87 to 89° F., the temperature being controlled by HVAC methods. Harvesting was performed when the observers determined by scent that an appropriate taste profile for the myceliated coffee product had been obtained.

Reduction of Caffeine and/or Undesirable Taste Components During Myceliation

The myceliation step may also cause reduction and/or removal of undesirable taste components as described herein and/or caffeine. In some embodiments, determination of the extent of the removal of at least one undesirable taste component is determined by the appearance, taste, and/or chemical composition of the myceliated coffee product as is known in the art. To effect the greatest reduction of undesirable taste components, the myceliation can, in some embodiments, proceed for upwards of one year.

In one embodiment, up to 5% of one or more of the undesirable taste components are removed; in other embodiments, up to 10%, up to 15%, up to 20%, up to 25%, up to 30%, up to 35%, up to 40%, up to 45%, up to 50%, up to 55%, up to 60%, up to 65%, up to 70%, up to 75%, up to 80%, up to 85%, up to 90%, or up to 95% of one or more of the undesirable flavor components are removed in the processes of the instant invention. In one embodiment, one or more of the undesirable flavor components are quantitatively removed. The invention also relates to myceliated coffee products having reduced levels of undesirable taste components as described herein.

In one embodiment, the undesirable taste component is 2-furanmethanol and up to 5% of 2-furanmethanol is removed; in other embodiments, up to 10%, up to 15%, up to 20%, up to 25%, up to 30%, up to 35%, up to 40%, up to 45%, up to 50%, up to 55%, up to 60%, up to 65%, up to 70%, up to 75%, up to 80%, up to 85%, up to 90%, or up to 95% of 2-furanmethanol is removed in the processes of the instant invention. The invention also relates to myceliated coffee products having reduced levels of 2-furanmethanol as described herein.

In one embodiment, the undesirable taste component is a diketopiperazine and up to 5% of diketopiperazines are removed; in other embodiments, up to 10%, up to 15%, up to 20%, up to 25%, up to 30%, up to 35%, up to 40%, up to 45%, up to 50%, up to 55%, up to 60%, up to 65%, up to 70%, up to 75%, up to 80%, up to 85%, up to 90%, or up to 95% of diketopiperazines are removed in the processes of the instant invention. The invention also relates to myceliated coffee products having reduced levels of diketopiperazines as described herein.

In one embodiment, the undesirable taste component is 1-methylpyrimidine and up to 5% of 1-methylpyrimidine is removed; in other embodiments, up to 10%, up to 15%, up to 20%, up to 25%, up to 30%, up to 35%, up to 40%, up to 45%, up to 50%, up to 55%, up to 60%, up to 65%, up to 70%, up to 75%, up to 80%, up to 85%, up to 90%, or up to 95% of 1-methylpyrimidine is removed in the processes of the instant invention. The invention also relates to myceliated coffee products having reduced levels of 1-methylpyrimidine as described herein.

In one embodiment, caffeine is removed from the prepared coffee beans during the culturing or myceliation step. In one embodiment, up to 5% of caffeine is removed; in other embodiments, up to 10%, up to 15%, up to 20%, up to 25%, up to 30%, up to 35%, up to 40%, up to 45%, up to 50%, up to 55%, up to 60%, up to 65%, up to 70%, up to 75%, up to 80%, up to 85%, up to 90%, or up to 99% of caffeine is removed in the processes of the instant invention. The invention also relates to myceliated coffee products having reduced levels of caffeine as described herein.

Other taste defect molecules include furfural, trigonelline, and dihydroxylated arenes. Trigonelline and caffeine generally exhibit the lowest reduction, unless the strain has been trained to better recognize these molecules. The inventors caution against extensive trigonelline reduction, as some amount of trigonelline adds to the overall body and aroma of the brew.

Removal of undesirable taste components results in increasing the value of poorer quality coffee and/or rendering it more drinkable. Myceliated coffee products produced by this method may be used to blend with less expensive coffee beans leading to a lower cost product having improved taste properties. The amount of sugar, milk, and substitutes to be added to the coffee may be reduced. The instant methods lead to an enhanced flavor profile of the myceliated coffee products due to a perception that the myceliated coffee products provide a richer, smoother, and/or sweeter coffee with less bitter, harsh, and/or acidic tastes.

Addition of Flavor and/or Health Promoting Components

The myceliation processes of the instant invention, in some embodiments, provide a myceliated coffee product with added flavor and/or heath promoting components. For example, the myceliated coffee products may contain exogenously added anti-tumor and immunomodulatory health promoting components.

Fungi are metabolically similar to animals but structurally similar to plants in that they possess a rigid cell wall formed largely of long sugar molecule chains joined by somewhat difficult to digest beta (β-) linkages and to a smaller extent more easily digestible alpha (α-) linkages in conjunction with membrane-bound proteins, glycoproteins, and glycolipids. In contrast, plant cell walls (such as those in green coffee beans) are made of cellulose polysaccharides whose (1->4) β-glucan linkages are impossible for humans to digest but are digestable by fungi. Fungi cell walls are primarily composed of (1->3) β-glycosidic linkages, with (1->6) saccharide moiety side chains, and therefore may be broken down by minimal processing using water, heat, enzymatic, and mechanical treatment into smaller, more easily digestible, immunologically active polysaccharide molecules of variable microparticulate size. The immune response to fungal (1->3)(1->6) β-glucan (hereinafter referred to as β-glucan) is dependent upon the (1->6) sidestructure, which has primary, secondary, and tertiary chiral structures, explaining the differences in immune response to each fungus's unique β-glucan profile. Myceliated coffee products thus have added health promoting components including the molecules described above. Other health promoting components present in the myceliated coffee products may be components that have various properties such as immunomodulating, anti-aging, aphrodisiac, anti-tumour, anti-viral, anti-bacterial, and/or anti-fungal properties and include compounds such as α- and β-glucans, glycoproteins, proteins, peptides, ergosterols, sterols, triterpenes, fatty acids, nucleic acids, and others, depending on strain.

Agaricus blazei may be used for addition of unique α- and β-linked glucomannans and riboglucans, which are anti-viral, into the myceliated coffee product. Other A. blazei polysaccharide extracts may have anti-cancer effects and may be co-therapeutic with other mycelial extracts or myceliated coffee products. Therefore, myceliation with A. blazei and myceliated coffee products containing flavor and/or health promoting components derived from A. blazei as described herein are also included in the instant invention.

Cordyceps sinensis produces cordycepin, adenosine, and cordycepinadenosine which are immunomodulating and anti-viral. C. sinensis extracts have been shown to be anti-aging and aphrodisiacal. Mycelial sterols isolated from C. sinensis have been shown to inhibit the proliferation of numerous cancer cell lines. C. sinensis mycelial polysaccharide extract has been shown to induce hypoglycemia. Therefore, myceliation with C. sinensis and myceliated coffee products containing flavor and/or health promoting components derived from C. sinensis as described herein are also included in the instant invention.

Flammulina velutipes mycelium has been shown to have a polysaccharide profile that is immunomodulating. F. velutipes mycelium composes a unique ergosterol and amino acid profile, sterpuric acid, mannitol, ribitol, and the nucleosides guanosine and adenosine, Enokipodins A-D extracted from F. velutipes mycelium are broad spectrum anti-microbial terpenes. The proteins flammulin and velutin exhibit anti-HIV and anti-HPV activity. Therefore, myceliation with F. velutipes and myceliated coffee products containing flavor and/or health promoting components derived from F. velutipes as described herein are also included in the instant invention.

Ganoderma lucidum's polysaccharide profile has been shown to be immunomodulating in human cell lines and also in clinical studies. G. lucidum mycelial extracts have anti-peroxidative, anti-inflammatory, and anti-mutagenic properties. G. lucidum extracts have been shown to be anti-aging and aphrodisiacal. The triterpenoid profile of G. lucidum has been determined and shown to be anti-hepatotoxic and hepatoprotective, anti-tumor, anti-angiogenic, anti-hypertensive, hypocholesterolemic, anti-histaminic, and anti-HIV. G. lucidum, in addition to producing polysaccharides and glycoproteins, likewise produces triterpenes, such as ganoderic and lucidenic acids, phenolic compounds, and sterols which also have high biological activity and therapeutic properties and are in themselves anti-oxidants, anti-tumor, anti-bacterial, anti-cancer, anti-inflammatory, anti-histaminic, hypotensive, sedative, and meditative after oral consumption. Therefore, myceliation with G. lucidum and myceliated coffee products containing flavor and/or health promoting components derived from G. lucidum as described herein are also included in the instant invention.

Grifola frondosa's polysaccharide profile has been shown to be immunomodulating and anti-oxidative. G. frondosa produces ergosterols and an anti-oxidative profile of fatty acids. The anti-tumor effects of G. frondosa extracts on in vitro cancer cell lines have been investigated, and shows promise for diabetes patients as being hypoglycemic. Therefore, myceliation with G. frondosa and myceliated coffee products containing flavor and/or health promoting components derived from G. frondosa as described herein are also included in the instant invention.

Hericium erinaceus mycelial and fruiting body extracts have been shown to be anti-mutagenic and immunomodulatory across various cell lines. H. erinaceus uniquely produces hericenones in fruit bodies and erinacines in mycelium, structurally determined compounds that can pass the blood-brain bather and promote secretion of Nerve Growth Factor (NGF) in certain regions of the brain. Erinacenes have been shown to be greater potentiators of NGF expression than hericenones. Therefore, myceliation with H. erinaceus and myceliated coffee products containing flavor and/or health promoting components derived from H. erinaceus as described herein are also included in the instant invention.

Aspects of Lentinula edodes' polysaccharide profile have been determined and shown to be immunomodulating and antiviral. Lentinan and other metabolites have been studied for their numerous health care benefits. In some countries, lentinan is classified as an “anti-neoplastic polysaccharide” and is available for clinical use. Addition of lentinan to standard cancer therapies has been shown to result in increased tumor necrosis and with hepatocellular carcinoma and improved quality of life in patients with esophageal carcinoma. Therefore, myceliation with L. edodes and myceliated coffee products containing flavor and/or health promoting components derived from L. edodes as described herein are also included in the instant invention.

Phellenis linteus extracts have been shown to exhibit antitumor activity. Polyporus umbellatus polysaccharide extracts have been studied and shown to be anti-cancer, immunomodulating, anti-malarial, and hepatoprotective. Inonotus obliquus mycelial polysaccharide extract has demonstrated anti-tumor, hypoglycemic, and anti-oxidative properties. Pleurotus ostreatus mycelium and fruit body composition have been shown to be very similar, differing only in amino acid content. The mycelial polysaccharide profile consists primarily of laminarin, the extract of which has been shown to be immunomodulating. Lovastatin, isolated from the mycelial broth of P. ostreatus, exhibits anti-carcinoma activity, inhibits growth of bacteria and fungi, and lowers cholesterol. Trametes versicolor produces heteroglucans with α-(1->4) and β-(1->3) glycosidic linkages with fucose in the glycoprotein PSK (Krestin). Along with rhamnose and arabinose in PSP, these glycoproteins have been shown to be anti-tumor and immunomodulatory. PSK, an approved drug in some nations, is in mycelial extract and exhibits immunomodulating, anti-viral, and cholesterol regulating properties. Mycelial polysaccharide extracts of Tremella fuciformis have been shown to be therapeutic for various circulatory disorders, to be neurologically healthy, anti-carcinoma, anti-tumor, and anti-aging.

Therefore, myceliation with Phellenis linteus, Polyporus umbellatus, Inonotus obliquus, Pleurotus ostreatus, Trametes versicolor, and/or Tremella fuciformis (and any other fungal species described herein), and myceliated coffee products containing flavor and/or health promoting components derived from Phellenis linteus, Polyporus umbellatus, Inonotus obliquus, Pleurotus ostreatus, Trametes versicolor, and/or Tremella fuciformis (or any other fungal species described herein) are also included in the instant invention.

The amount of flavor components or health promoting components added by the fungal component as described herein can be estimated by one of knowledge in the art, and includes up to 1 ng of the component per unit myceliated coffee product, or up to 5 ng, up to 10 ng, up to 50 ng, up to 100 ng, up to 500 ng, up to 1 μg, up to 5 μg, up to 10 μg, up to 50 μg, up to 100 μg, up to 500 μg, up to 1 mg, up to 2 mg, up to 5 mg, up to 10 mg, up to 20 mg, up to 50 mg, up to 100 mg, or up to 500 mg per unit myceliated coffee product. A unit of myceliated coffee product can be variously defined as a unit of mass or weight, e.g. 1 g, 1 lb, or 1 kg.

### Further Processing of Myceliated Coffee Product

In some embodiments, once myceliated, the myceliated coffee product is optionally rinsed after myceliation. Rinsing may be performed to remove some or all parts of the mycelia and/or other non-green coffee bean matter.

In some embodiments, once myceliated, the myceliated coffee product is optionally dried. Drying can be accomplished by means known in the art for drying green coffee beans. For example, myceliated coffee product may be spread on a dry surface to dry in the ambient. A fan can be used to create a laminar air stream over the myceliated green coffee beans. An industrial coffee bean dryer can be used. In one embodiment, the myceliated coffee product is dried down to about an 11 to 13% moisture content.

Optionally, the dried or undried myceliated coffee product can be roasted and/or toasted by conventional methods known in the art. The roast profile of the beans, in some cases, is altered by the heat treatment step.

The myceliated coffee product may be brewed by methods known in the art to prepare a beverage for use in food and/or drink products.

### Specific Embodiments of the Invention

### Example 1

2½ gallon ball-jars were obtained, cleaned, and dried. The lids were outfitted such as to allow for gaseous diffusion into and out of the jars, and with tin-foil collars. The jars were half-filled with provided dried Arabica green coffee beans. Water was added to the jars so as to just cover the beans, and the beans soaked for 2 hours, at which point the water was decanted. The moisture content of the beans was estimated to be 30%. The jars were placed into 41 quart pressure-cookers in a clean-room and sterilized at 15 lb/in² for 90 minutes, and were then removed immediately into a sterile laminar flow hood to cool. Once cool, the jars of prepared green coffee beans were inoculated with whole Petri plate cultures of G. lucidum and C. sinensis, each culture into a separate jar. The cultures had been grown on an organic food medium comprising 40% (v/v) organic potato extract, 20% (v/v) organic carrot extract, 5 g/L organic ground celery, and 17 g/L agar for 12 days, having been propagated from a plate of similar media (additionally comprising 8 g/L organic turnip extract). The cultures myceliated in the laminar flow hood for 10 days. No vigorous myceliation was noted in the G. lucidum culture, though some myceliation was observed for C. sinensis. After 10 days, the myceliated green coffee beans were dried outside on a tarp for 2 days to an 11% moisture content, where after they were roasted by a professional coffee roaster and tasted. Both samples yielded tastes that were described as smoother, less bitter, and less acidic.

### Example 2

8, 1 gallon ball jars were obtained, cleaned, and dried. The lids were outfitted such as to allow for gaseous diffusion into and out of the jars, and with tin-foil collars. The jars were half-filled with provided dried Robusta green coffee beans. Water was added to the jars so as to just cover the beans, and the beans soaked for 2.5 hours, at which point the water was decanted. The moisture content of the beans was estimated to be 33%. The jars were placed into 41 quart pressure-cookers in a clean-room and sterilized at 15 lb/in² for 90 minutes, and were then removed immediately into a sterile laminar flow hood to cool. Once cool, the jars of prepared green coffee beans were inoculated with floating liquid tissue cultures of M. angusticeps, T. versicolor, H. erinaceus, V. volvacea, P. nameko, F. velutipes, and I. obliquus. The entire pancake of the floating cultures and approximately half of their liquid contents were added to the jars. The floating liquid tissue cultures were grown in a medium comprising 11 g/L organic potato starch, 18% (v/v) organic turnip extract, and 5 g/L organic wheat flour, for 15 days each, having been propagated from a Petri plate comprising an undefined organic food medium. The inoculated green coffee beans myceliated for 12 days, at which time they were dried on a tarp outside for two days to a 12% moisture content. The I. obliquus and F. velutipes cultures displayed resplendent growth. Once dry, the beans were roasted and tasted. All of the samples but the I. obliquus and M. angusticeps cultures exhibited a smoother taste than conventional Robusta coffee, with no bitter-aftertaste.

### Example 3

18 provided 2.2 mm polypropylene bags of dimensions 5″×8″×19″ (width×depth×height) were each filled with 2.9 kg of dried, provided Robusta green coffee beans at an initial moisture content of 8.6%. 1.52 L of RO water was added to each bag, and the bags were wrapped around the water/green coffee bean mass so as not to invert or tilt the bags. The bags were then loosely wrapped with EPDM bands to hold the shape of the wrap. The 16 prepared bags were placed into an autoclave and sterilized for 140 minutes at 22 lb/in². Once sterilized, the bags were placed into a clean-space to cool. Once cool, the weight of the bags indicated that the moisture content of the beans had been raised to 40%. The bags were inoculated with submerged liquid tissue cultures of Hericium erinaceus, Pleurotus ostreatus, Trametes versicolor, Lentinula edodes, Tricholoma matsutake, Flammulina velutipes, Volvariella volvacea, Agaricus blazei, Grifola frondosa, Pholiota nameko, Ganoderma lucidum, Ganoderma applanatum, Morchella angusticeps, Morchella esculenta, Auricularia auricula, Tremella fuciformis, Laetiporus sulfureus, and Cordyceps sinensis. The submerged liquid tissue culture media consisted of 4 g/L organic potato starch powder and 0.4 g/L organic carrot powder, and was spiked with 10% (v/v) of aqueous green coffee bean extract. The aqueous green coffee bean extract was prepared by soaking 1 kg of Robusta green coffee beans in 2 gallons of RO water for 30 minutes. The filtrate was collected through 3 fine mesh filtrations, and 150 mL was added to 1,350 mL of the organic potato starch and organic carrot powder media, to create 1.5 L of media in 4 L Erlenmeyer flasks. The flasks were sterilized at 22 lb/in² for 140 minutes, cooled, and inoculated from a Petri plate consisting of 8 g/L organic potato starch powder, 20% (v/v) organic mango puree, and 16 g/L agar, and cultured for 6 days on a shaker table with a 1″ swing radius and 120 RPM shaking rate. The coffee cultures myceliated for 8 days at a temperature of 85° F., at which point the P. ostreatus, T. matsutake, F. velutipes, G. lucidum, M. angusticeps, T. fuciformis, and C. sinensis cultures demonstrated vigorous mycelial growth. After 8 days, the cultures were dried on drying racks, the beans lying on clean paper-towel, in front of industrial fans for 2 days, where they finally had a moisture content of 11%. The beans were then roasted and tasted. All of the cultures demonstrated great flavor changes compared to non-myceliated control beans, though the P. ostreatus, I. obliquus, and M. angusticeps cultures brought out some undesirable fungal notes, though the aftertastes of these samples were completely mitigated.

### Example 4

20 provided 2.2 mm polypropylene bags of dimensions 5″×8″×19″ (width×depth×height) were each filled with 2.9 kg of dried, provided Arabica green coffee beans at an initial moisture content of 9.2%. 4.42 L of RO water was added to each bag, and the bags were wrapped around the water/green coffee bean mass so as not to invert or tilt the bags. The bags were then loosely wrapped with EPDM bands to hold the shape of the wrap. The 16 prepared bags were placed into an autoclave and sterilized for 140 minutes at 22 lb/in². Once sterilized, the bags were placed into a clean-space to cool. Once cool, the weight of the bags indicated that the moisture content of the beans had been raised to 64%. The bags were inoculated with submerged liquid tissue cultures of Hericium erinaceus, Pleurotus ostreatus, Trametes versicolor, Lentinula edodes, Tricholoma matsutake, Flammulina velutipes, Volvariella volvacea, Agaricus blazei, Grifola frondosa, Pholiota nameko, Ganoderma lucidum, Ganoderma applanatum, Laetiporus sulfureus, Auricularia auricula, Morchella angusticeps, Morchella esculenta, Auricularia auricula, Tremella fuciformis, Laetiporus sulfureus, and Cordyceps sinensis. The submerged liquid tissue culture media consisted of 6 g/L organic potato starch powder, 0.7 g/L organic carrot powder, 10% (v/v) organic mango puree, and was spiked with 20% (v/v) of aqueous green coffee bean extract. The aqueous green coffee bean extract was prepared by soaking 1.2 kg of Arabica green coffee beans in 1.5 gallons of RO water for 30 minutes. The filtrate was collected through 3 fine mesh filtrations, and 300 mL was added to 1,200 mL of the organic potato starch and organic carrot powder media, to create 1.5 L of media in 4 L Erlenmeyer flasks. The flasks were sterilized at 22 lb/in² for 140 minutes, cooled, and inoculated from a Petri plate consisting of 9 g/L organic potato starch powder, 15% (v/v) organic mango puree, and 18 g/L agar, and cultured for 7 days on a shaker table with a 1″ swing radius and 120 RPM shaking rate. The coffee cultures myceliated for 10 days at a temperature of 85° F., at which point all of the cultures demonstrated vigorous mycelial growth. After the 10 days, the cultures were dried on drying racks, the beans lying on clean paper-towel, in front of industrial fans for 2 days, where they finally had a moisture content of 11%. The beans were then roasted and tasted. All of the cultures demonstrated favorable flavor changes compared to non-myceliated control beans, though the P. ostreatus, I. obliquus, and M. angusticeps cultures brought out some undesirable fungal notes, though the aftertastes of these samples were completely mitigated.

### Example 5

Specific and pure strains of Fungi obtained from referenced collections were manipulated in sterile environments in 1 gal to 10 gal plastic bags, 1 qt to 1 gal glass jar, or on 10 cm to 15 cm petri plates, using undefined, organic fruit and vegetable-based media including green coffee bean extract with 1.5% agar (w/v), in order to monitor and ensure the general vigor and health of strains.

Mycelial samples were grown in a gentle, ambient sterile airflow for 2 to 4 weeks, then excised from petri plates and subsequently used for inoculation into liquid-state fermentation employing a similar undefined fruit and vegetable-based media (but with no agar), using ambient air, in 1 qt to 1 gal glass jars. Some samples were grown in agitated and some were grown in unagitated cultures in ambient air in stainless steel tanks designed for commercial beer brewing and/or fermentation.

The unagitated liquid state fermentation formed a floating mass of hyphae which exhibited continuous growth at interface of liquid and air. The mycelium of agitated and/or swirling cultures grew very quickly as hyphael spheres, which being hydrated, remained submerged, and had the appearance of gelatinous beads in small diameter. Hydrated hyphael spheres collapsed upon desiccation, wherein they were used for inoculating petri plates for strain propagation and quality control.

Sphere diameter in liquid-state fermentation was found to be inversely proportional to agitation intensity and volume. Hyphael shear became more efficient at higher agitation and swirling intensity, and once sheared, hyphae formed new spheres of smallest possible diameter, growing in size until they sheared again. When employed in continuous liquid-state fermentation, there existed a constant ratio of sphere diameters, and therefore a constant supply of spheres on the order of microns was produced.

Thus, this example demonstrated that mycelia sphere diameter was manipulated for more efficient inoculation with inoculation efficiency being inversely proportional to sphere diameter.

### Example 6

Mycelial cultures from unagitated liquid state fermentation (growth period of 2 to 4 weeks) formed a floating mass of hyphae, which were gently blended with a sharp, sterile cutting device prior to being used for inoculation. Gentle blending was achieved by mixing or low homogenization in a commercial blender in short bursts at slow speeds. Aliquots of blended liquid-state culture were used to inoculate sterilized unprocessed fruits and or vegetables, cereal grains, and/or culinary seed, or pasteurized culinary spice, medicinal herbs, natural flavorings, tea mixes, green vanilla beans, green cocoa beans, and green coffee beans.

### Example 7

Substrates for myceliation (containing both substrate and inoculated mycelial culture) in jars or bags were gently mixed every few days until they commanded the substrate and became somewhat resistant to mixing or shaking, usually 2 to 4 weeks depending upon strain. The products were then in a tempeh form. The myceliated green vanilla beans were cooked or baked; the myceliated green cocoa beans were baked or toasted; and the myceliated green coffee beans were toasted or roasted. Myceliated grain presented in tempeh form, or as an ingredient in food(s) including soups, stir fries, breads, and meat-substitutes, was made safe to eat, and bio-available, by cooking on low to medium heat, 145° F. to 165° F., for 10 min to 60 min, at some point prior to consumption. Other cultures in jars or bags, such as herbs and spices were dried at 100° F. to 145° F. for 1 h to 24 h, packaged and used conventionally.

Myceliated honey formulations were stirred for 10 min to 90 min at 100° F. to 125° F., then poured into small glass bottles. Moreover, myceliated agricultural products were reformulated into value added products such as egg noodles, meat substitutes, specialty flavorings, cooking sauces, soup ingredients and the like.

### Example 8

For a large batch liquid-state and solid-state operation, pure cultures were grown aerobically and inoculated into large industrial liquid-state and large solid-state commercial processors operated continuously and semi-anaerobically for large-scale fermentation of food products. After cultures of media turned completely white or a representative color thereof for a particular species, and had completely overgrown and commanded the medium and were resistant to gentle mixing, the contents were harvested, removed to plastic bags and refrigerated for quick use at either 40° F., or frozen for long-term storage, and subsequent utilization, at −20° F. Fermented media were prepared into gourmet human foods including: “tempeh style” meat substitutes, egg-noodles, specialty flavorings, breads, extracts and cooking-sauces, or used directly as a fresh ingredient in soup and/or stir fried recipes, or packaged.

### Example 9

Agricultural substrates completely myceliated by inoculating with pure cultures of fungal strains selected from A. blazei, C. sinensis, G. lucidum, H. erinaceus, G. frondosa, P. eryngii, P. ostreatus, P. citrinopileatus, P. djamor, T. versicolor, L. edodes, F. velutipes, V. volvacea, H. marmoreus, P. nameko, T. melanosporum, M. hortensis, P. umbellatus, and T. fuciformis were subjected to heat treatment 1 hour to 24 hours prior to harvest for 1 min to 2 hours at 145° F. to 195° F. followed by recovery at room temperature for 45 min to 48 hours. This process showed remarkable decrease in RNA levels and were formulated into different nutraceutical compositions.

### Example 10

### Small Batch Work

48 lbs. of coffee was divided into 48 equal portions in clean quart ball jars with lids constructed to enable gaseous diffusion past a collar. These 48, 1 lbs. masses of coffee were soaked with ¾ quart of water for two hours. The water in the mixtures was filtered off. The jars of coffee were then subjected to 90 minutes of sterilization temperatures at 15 psi, and placed in a sterile laminar air flow to cool for 8 hours. Once cool, the prepared green coffee beans were inoculated with half to whole colonies of fungus selected from one of the following: Ganoderma lucidum, Cordyceps sinensis, Tuber melanosporum, Hericium erinaceus, Agaricus blazei, Grifola frondosa, Pleurotus ostreatus, Trametes versicolor, Laetiporus sulphureus, Flammulina velutipes, Lentinula edodes, Morchella angusticeps, Morchella crassipes, Morchella hesculenta, Tremella fuciformis, and Inonotus obliquus, doing three of each, growing on an undefined vegetable and fruit juice agar media containing green coffee extract as described in Example 8, with sterile tools and in sterile operation inside the laminar flow hood. The cultures myceliated for 7 to 21 days, with samples of each being pulled out for drying and roasting at the 7^{th}, 14^{th}, and 21^{st} days. The smell of the culture and taste of the myceliated green coffee beans at the 7^{th} day indicated that the cultures were complete, though longer myceliation periods yielded greater cell mass.

### Large Batch Work

528 lbs. of green coffee beans were soaked in two different procedures. In the first procedure, the beans were soaked three times, for 20 minutes each soak, in the second procedure, the beans were soaked for 20 minutes through a constant stream of filtered water. The beans were then packed into polypropylene bags with 0.2 micron breather patches, with the tops of the bags folded over with rubber bands wrapped around the sides of the bags, such that steam and gas diffusion could occur through breather patch and through the folded sides of the bags. The bags were sterilized under a liquid cycle at 22 psi for 80 minutes, and then allowed to cool for 8 hours. The bags were inoculated with fungi from the following species: Ganoderma lucidum, Cordyceps sinensis, Tuber melanosporum, and Morchella angusticpes. The Ganoderma lucidum culture was grown in a bioreactor, with 10 L of organic potato extract, 2 L of green coffee extract, and 1 L organic mango juice diluted to 100 liters with RO water. The bioreactor was sparged with compressed air filtered through two inline 0.2 micron hydrophobic capsule filters, and the reactor was kept under 2-3 psi through the use of check valves on the air supply and venting lines with 2-3 psi cracking pressure ratings. The inoculant was readily grown in 48 hours, and was harvested through a diaphragm valve located at the bottom of the reactor, which led to a harvesting line that had teed and valved off access to a steam line and steam trap, with an inline check valve, through six feet of flexible stainless steel hosing, to a solenoid valve connected to a timer and foot switch, followed by a flow metering valve to an elbowed sanitary fitting. While being steamed, the elbowed sanitary fitting was connected to a ball valve that connected to the steam exhaust manifold. The ball valve was closed after steaming the line, and the ball valve was detached from the harvesting line once entered into a laminar flow hood, so as to keep the whole line sterile. The Cordyceps sinensis, Tuber melanosporum, and Morchella angusticeps cultures were grown in 4 L flasks, in 1.5 L of the same media used in the bioreactor pre-dilution. These cultures were grown for six days, and were used to inoculate the bags of sterilized green coffee beans. The beans were myceliated for 7 days, where their smell conferred the desired taste profile of the beverage made from the roasted myceliated beans, whereupon they were dried on the 8^{th} day to a 13% moisture content.

### Example 11

A suitable fungi for use in the methods of the present invention was prepared by the following methods. The following G. lucidum strains were purchased commercially from the Pennsylvania State University mushroom culture collection: 496 Ling ZHI; Singapore commercial line; 7/85; 502 IFO #8436; IFO-Japan; 7/30/85; 510 Red oak, State College, Pa.; D. J. Royse; 9/85; 549 Y. H. Park, ASI-Korea; 12/5/85; 550 Y. H. Park, ASI-Korea; 12/5/85; 551 Y. H. Park, ASI-Korea; 12/5/85; 580 Y. H. Park, ASI-Korea; 2/10/85; 607 Y. H. Park, ASI-Korea; 2/19/85; 617 Y. H. Park, ASI-Korea; 2/25/85; 618 Y. H. Park, ASI-Korea; 2/25/85; 619 Y. H. Park, ASI-Korea; 2/25/85; 620 Y. H. Park, ASI-Korea; 2/25/85; 621 Y. H. Park, ASI-Korea; 2/25/85; 622 Y. H. Park, ASI-Korea; 2/25/85; 623 Y. H. Park, ASI-Korea; 2/25/85; 624 Y. H. Park, ASI-Korea; 2/25/85; 625 Y. H. Park, ASI-Korea; 2/25/85; 626 Y. H. Park, ASI-Korea; 2/25/85; 627 Y. H. Park, ASI-Korea; 2/25/85; 665 Quimio; Philippines; 3/6/86; 669 Y. H. Park, ASI-Korea; 3/25/86; 686 B. W. Yoo; 4/28/86; 724 T. Mitchel, Lawn PSU Forestry Bldg. 9/16/90; 806 Alice Chen; Buffalo, N.Y.; 4/94; 807 Alice Chen; North Carolina; 4/94; 841 White Oak; PSU Campus; J. Peplinski; 8/99. The above strains were cultured using the media described herein comprising green coffee bean extract (see Example (9). Many strains were unable to grow and/or died on the media. Surprisingly, the inventors found that G. lucidum strain 806 Alice Chen; Buffalo, N.Y. was able to grow on the media comprising green coffee bean extract and was selected for further use in accordance with the instant invention.

### Example 12

Fungi (including G. lucidum strain 806, C. sinensis, and T. melanosporum as described herein, also H. erinaceus, T. versicolor, L. edodes, T. matsutake, F. velutipes, A. blazei, G. frondosa, P. nameko, L. officinalis, M. hortensis, M. angusticeps, A. auricula, T. fuciformis, I. obliquus, F. fomentarius, L. sulfureus) were maintained on a culture comprising an undefined media including extract of green coffee beans. Experiments showed that use of the media including extract of green coffee beans to culture the maintained the fungi's ability to tolerate, grow on, metabolize, remove or reduce caffeine or undesirable flavor components. It was also found that successive propagations of fungi as defined above caused enhancement and/or improvement of the fungi's ability to tolerate, grow on, metabolize, remove or reduce caffeine or decrease undesirable flavor components, resulting in training or adapting the fungi to undefined media including extract of green coffee beans. Such fungi with changed, improved, and adapted properties as described herein, relative to the starting strains, either selected or unselected, were developed. These adapted strains were deposited with the ATCC as described elsewhere herein.

The undefined media including extract of green coffee beans was made as follows: 2 lbs green coffee beans, pulverized was mixed with ¼ gallon water at room temperature. The mixture was allowed to extract for 20 minutes with shaking, then filtered three times through fine mesh. Separately, about 5 organic potatoes were placed in 10 L of water and autoclaved 20 minutes to soften the potatoes. The potatoes were then pulverized with a potato masher, and then filtered through fine mesh three times. 1 L of commercial unsweetened fruit juice was be added. These solutions are combined and autoclaved. This recipe was also scaled up or down as required.

The washed green coffee beans were soaked in water and the moisture content was raised to about 30%. At other times the moisture content was raised to about 60%. At this point, the bean as well quenched of chlorogenic acid, as evidenced by the lack of green seen in the bean. Some chlorogenic acid was left in the bean, though much of it is obviously and evidently removed. Removal of chlorogenic acid from green coffee beans allowed good myceliation at moisture contents of 30% and greater, whereas green coffee beans that did not have a chlorogenic acid removal step required a moisture content of 60% for good myceliation.

Liquid culture: The culture comprising fungi for use in inoculating the prepared green coffee beans was agitated with sparged air and a motorized paddle to create turbulent environment and to shear hyphae with pure mechanical force. The dual agitation method was superior to either method individually, since sparged air created the most turbulence at the top half of the culture, while affecting the bottom less, which was agitated by a motorized paddle. In return the paddle could be run at a lower RPM and still obtain the hyphal sphere size obtained by a faster RPM in the absence of sparging. The hyphal size was about 2-5 micron in diameter). Undamaged mycelium and proper morphology in the prepared fungi were prepared by this method and used for culturing and/or myceliation.

### Example 13

### Analysis

The myceliated coffee products including roasting myceliated coffee beans and roasted grounds produced by the methods of the instant invention contain exogenous polysaccharides. A third-party analysis (done by Brunswick Labs) showed that Robusta coffee grounds produced by the methods of the invention had 30.54 mg dextran per gram of coffee grounds derived from a G. lucidum coffee bean culture. This result provided the total polysaccharide amount in the substrate through a spectrophotometric method based on a modified phenol-sulfuric acid hydrolysis approach. The analysis also showed that Robusta coffee grounds produced by the methods of the invention had fungal β-glucans at 0.432%. This represents an advantage over consuming β-glucans from G. lucidum fruit-body, as these mushrooms are a non-culinary mushroom for reasons of bitterness, woodiness, and hardness, or in any fungal extract formulated into a pill, as pills do not present fungal metabolites in a highly bio-available form.

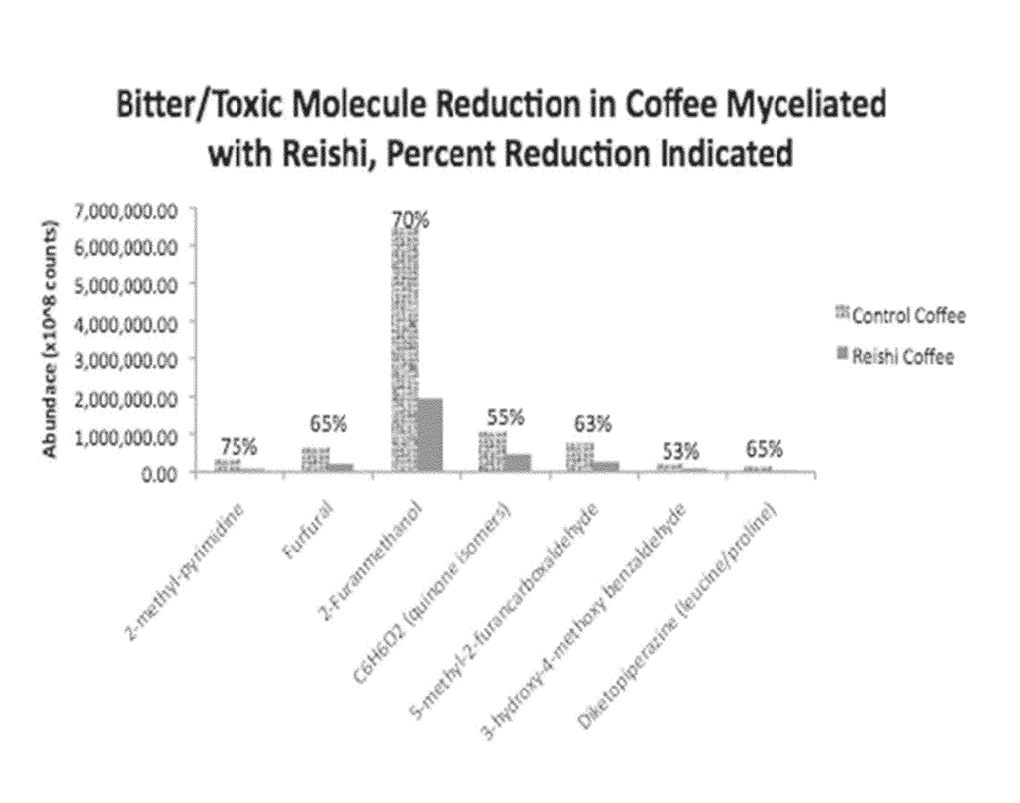

A confidential third party performed an HPLC MS/MS study on the brew of Arabica coffee beans myceliated with G. lucidum. The moisture content of the beans, which were inoculated from a submerged liquid tissue culture, were not high enough to effect vigorous mycelial growth, though small amounts of myceliation were observed. Against a non-myceliated control sample, the laboratory found decreased concentrations of various undesirable flavor compounds. The results of the study are summarized FIG. 1, which shows the relative abundance of a number of bitter/toxic molecules from brewed coffee which had been myceliated by the methods of the present invention (Reishi coffee) and control coffee, which was not treated by methods of the present invention. Of note, there was a 75% reduction in the amount of 2-methyl-pyrimidine, a 65% reduction in the amount of furfural, a 70% reduction in 2-furanmethanol, a 55% reduction in quinone isomers, a 63% reduction in 5-methyl-2-furancarboxaldehyde, a 53% reduction in the amount of 3-hydroxy-4-methyoxy benzaldehyde, and a 65% reduction in the amount of diketopiperazine.

### Example 14

### Taste Tests

Taste Test 1: Sumatran, Peruvian, and Honduran Arabica beans myceliated with G. lucidum

A coffee roasting professional and owner of a coffee roasting business (tasters) taste-tested, in a double-blind trial, a comparison of standard premium coffee beans using Sumatran, Peruvian, and Honduran Arabica beans (control beans) with coffee beans produced by the methods of the present invention (myceliated beans). Both myceliated beans and control beans were roasted on the day of the trial. These were cupped side-by-side with the control, using standard coffee tasting techniques.

The flavor-enhancing effects of the myceliation were confirmed. The tasters sampled myceliated and normal brews of each variety in this double-blind taste test. Notes were taken and comments recorded. At the conclusion of the tasting, the coffee beans used for each cup were identified.

Commenting first on the myceliated Sumatra it was described as having a fuller body, more complex, and less bitter flavor than the control Sumatra. The tasters stated that this was the only process they were aware of that actually removed a taste defect and enhanced the flavor.

The myceliated Peruvian showed a noticeable flavor-enhancement as well, being a less bitter, more sweet, and a markedly “brighter” cup when myceliated. Despite being a high-quality bean, the control Peruvian tasted “flat” by comparison.

Out of the two tasters, one taster was able to taste a difference in the Honduran brew. The methods of the invention resulted in removing the bitter compounds found in coffee resulting in a better tasting cup of coffee.

Taste Test 2: Sulawesi Arabica Beans

A myceliated coffee taste test was held at a coffee house. The barista/roaster (taster) delivered the formal cupping of their in-house Sulawesi Arabica coffee (Indonesian in origin) myceliated with G. lucidum. The beans were selected from inventory and both the myceliated and control beans were roasted the day of the cupping. The results showed that myceliated coffee (produced by the methods of the invention) had an improved flavor profile.

The taster described the myceliated coffee as less acidic, sweeter, fuller in body, more complex and overall a better taste than the original bean. Several other participants in the taste test and also noticed the flavor-enhancement found in myceliated coffee.

Taste Test 3: Robusta Beans

A coffee roasting professional and owner of a coffee roasting business (tasters) in a double-blind trial, conducted a taste comparison of myceliated Robusta coffee beans with control non-myceliated Robusta coffee beans produced by the methods of the present invention. Coffee made from 100% Robusta beans is generally considered undrinkable due to the high acidity and bitterness of Robusta. Thus, Robusta coffee beans are not typically used alone, instead, Robusta beans are typically blended with more expensive beans to make it palatable.

The tasters agreed that myceliated Robusta is “hands-down” a better cup of coffee than non-myceliated. One taster commented that “you have proved beyond a doubt that your technology works”; the other taster commented that he is a self-proclaimed coffee snob and that he “would drink this myceliated Robusta on a daily basis”, simultaneously remarking that the non-myceliated coffee was unpalatable. More specifically, he noticed a conspicuous lack of bitterness and acidity in the cup, with a fuller body in the taste. The tasters remarked that a non-professional coffee taster would be able to taste and appreciate the difference, and that myceliated Robusta holds great value in the marketplace. Other employees of the roasting company also noticed the difference.

The taste testing results clearly demonstrate that the instant processes enhance the taste of coffee. The results showed that the processes of the invention removed taste defects like bitterness from both Arabica and Robusta coffee beans and enhanced their flavor and value. The processes result in a less-bitter, sweeter, fuller-bodied, and more complex tasting coffee with either Robusta or Arabica beans.

What is claimed is:

1. A method for the preparation of a myceliated coffee product, comprising:
a) providing prepared green coffee beans comprising the steps of:
i. providing green coffee beans
ii. heat treating the green coffee beans to provide prepared green coffee beans;
b) providing a prepared fungal component;
c) inoculating the prepared green coffee beans with the prepared fungal component; and
d) culturing the prepared green coffee beans and prepared fungal component to allow myceliation to result in the myceliated coffee product, wherein the myceliated coffee product is capable of being used to prepare a palatable coffee beverage for human consumption.

2. The method of claim 1, wherein the step of providing the green coffee beans comprises hydrating the green coffee beans to about a 60% moisture content.

3. The method of claim 1, wherein the step of providing the green coffee beans comprises hydrating the green coffee beans to about a 30% moisture content.

4. The method of claim 1, wherein the myceliated coffee product has a reduction in the amount of at least one undesirable taste component.

5. The method of claim 4, wherein the undesirable taste component is selected from the group consisting of 2-furanmethanol, a diketopiperazine, 1-methylpyrimidine, furfural, quinone isomers, 5-methyl-2-furancarboxaldehyde, and 3-hydroxy-4-methyoxy benzaldehyde.

6. The method of claim 1, wherein the myceliated coffee product has an increase in the amount of at least one fungal metabolite.

7. The method of claim 6, wherein the fungal metabolite is a fungal β-glucan.

8. The method of claim 1, which further comprises drying the myceliated coffee product to about an 11 to 13% moisture content.

9. The method of claim 1, which further comprises roasting the myceliated coffee product.

10. The method of claim 3, wherein the culturing step is for between about 1 to about 12 days.

11. The method of claim 1, wherein the prepared fungal component is selected from the group consisting of Hericium erinaceus, Pleurotus ostreatus, Pleurotus eryngii, Pleurotus citrinopileatus, Pleurotus djamor, Trametes versicolor, Lentinula edodes, Armillariella mellea, Tricholoma matsutake, Flammulina velutipes, Volvariella volvacea, Agaricus campestris, Agaricus blazei, Grifola frondosa, Pholiota nameko, Boletus edulis, Ganoderma lucidum, Ganoderma applanatum, Hypsizygus marmoreus, Morchella hortensis, Morchella angusticeps, Morchella esculenta, Phellinus linteus, Auricularia auricula, Tremella fuciformis, Inonotus obliquus, Fomes fomentarius, Laetiporus sulfureus, Cordyceps sinensis, Cordyceps militaris, Polyporus umbellatus, and combinations thereof.

12. The method of claim 11, wherein the prepared fungal component is G. lucidum.

13. The method of claim 12, wherein the prepared fungal component is G. lucidum strain 806.

14. The method of claim 12, wherein the prepared fungal component is C. sinensis.

15. The method of claim 1, wherein the prepared fungal component is prepared by a method comprising screening a number of strains of fungi and selecting a strain having an enhanced ability to tolerate, grow on, metabolize or utilize green coffee beans.

16. The method of claim 1, wherein the prepared fungal component is prepared by a method comprising maintaining a strain of fungi on an undefined organic food media comprising an aqueous green coffee bean extract in the absence of an exogenous nitrogen source added separately from the organic food source(s).

17. The method of claim 1, wherein the culturing step is carried out under aerobic conditions wherein relative humidity and temperature are controlled.

18. The method of claim 1, wherein the culturing step is carried out for about 7 days.

19. The method of claim 1, wherein the green coffee beans are from the species Coffea arabica or Coffea robusta.

20. The method of claim 1, wherein the heat treatment step comprises pasteurization.

21. The method of claim 1, wherein the heat treatment step comprises sterilization.

22. A myceliated coffee product prepared by the method of claim 1.
